(19) United States
(12) Patent Application Publication
(10) Pub. No.: US 2026/0247168 A1
(43) Pub. Date: Aug. 20, 2026

(54) MODEL RELATION AND UNIFIED SWITCHING, ACTIVATION AND DEACTIVATION

(71) Applicant: QUALCOMM Incorporated, San Diego, CA (US)

(72) Inventors: Chenxi HAO, Beijing (CN); Hao XU, Beijing (CN); Rui HU, Beijing (CN); Taesang YOO, San Diego, CA (US)

(21) Appl. No.: 18/992,916

(22) PCT Filed: Aug. 20, 2022
(86) PCT No.: PCT/CN2022/113788

§ 371 Date: Jan. 9, 2025

(51) Int. Cl. H04W 24/02; H04B 7/06; H04L 41/16; H04W 60/04; H04W 76/20; H04W 80/02

(52) U.S. Cl. CPC H04W 24/02; H04B 7/0626; H04L 41/16; H04W 60/04; H04W 76/20; H04W 80/02

(57) ABSTRACT

Methods, systems, and devices for wireless communication are described. A user equipment (UE) may identify a set of groups, each group in the set of groups comprising a machine learning model for each of one or more functions implemented by the UE, each machine learning model corresponding to a condition in which each function is implemented by the UE. The UE may receive an indication to switch from a first group to a second group in the set of groups based at least in part on a threshold change of the condition. The UE may switch each associated function implemented by the UE from a first machine learning model associated with the first group to a second machine learning model associated with the second group based at least in part on the indication to switch.

### CROSS REFERENCE

The present Application is a 371 national phase filing of International PCT Application No. PCT/CN2022/113788 by HAO et al., entitled “MODEL RELATION AND UNIFIED SWITCHING, ACTIVATION AND DEACTIVATION,” filed Aug. 20, 2022, which is assigned to the assignee hereof, and which is expressly incorporated by reference in its entirety herein.

### FIELD OF TECHNOLOGY

The following relates to wireless communication, including model relation and unified switching, activation and deactivation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support model relation and unified switching, activation and deactivation. For example, the described techniques provide for grouping machine learning models from different functions according to the condition of the wireless network. For example, a user equipment (UE) may identify or otherwise determine a set of groups. Each group may generally include a machine learning model for one or more functions implemented by the UE and network entity (e.g., a first model for a first function, a second model for a second function, and so forth). In each group, the machine learning models included in the group for the different functions may each correspond to or otherwise be associated with a specific condition (e.g., a given Doppler condition, delay spread condition, non-line-of-sight (NLIOS) condition, line-of-sight (LOS) condition, indoor condition, outdoor condition, network feature including antenna layout and beamforming schemes, and the like). In some examples the UE may define the groupings with the network entity, the network entity may define the groupings and notify the UE of the groupings, or the network entity and UE may cooperate to define the groupings. This may enable the network entity to rely on unified signaling techniques where the network switches the UE from a first group to a second group based on a change in the condition. This may enable the network to switch from the current group corresponding to the first condition (e.g., the old condition) to a second group corresponding to a second condition (e.g., the new condition) for each function being implemented in the wireless network. That is, registering the models for different functions but corresponding to a given condition into groups may enable the network to configure, activate, and deactivate models for multiple functions based on updated conditions within the network.

Additionally, or alternatively, when one or more machine learning models (e.g., a first machine learning model) within a group for a function fails to satisfy performance thresholds, this may indicate that the condition associated with the group for the corresponding function may have changed such that the current group of machine learning models are incorrect under the changed condition. Accordingly, the UE may transmit a report to the network that carries or otherwise conveys an indication that the group (e.g., identifying the specific group, the model within the group, or both) has failed to satisfy the performance threshold(s). The network entity may optionally, in response to the group failure report, transmit a switching indication directing the UE to switch from the current group (e.g., a first group) to a different group (e.g., a second group) that corresponds more closely to the changed condition.

A method for wireless communication at a UE is described. The method may include identifying a set of groups, each group in the set of groups including a machine learning model for each of one or more functions implemented by the UE, each machine learning model corresponding to a condition in which each function is implemented by the UE, receiving an indication to switch from a first group to a second group in the set of groups based on a threshold change of the condition, and switching each associated function implemented by the UE from a first machine learning model associated with the first group to a second machine learning model associated with the second group based on the indication to switch.

An apparatus for wireless communication at a UE is described. The apparatus may include a processor, memory coupled with the processor, and instructions stored in the memory. The instructions may be executable by the processor to cause the apparatus to identify a set of groups, each group in the set of groups including a machine learning model for each of one or more functions implemented by the UE, each machine learning model corresponding to a condition in which each function is implemented by the UE, receive an indication to switch from a first group to a second group in the set of groups based on a threshold change of the condition, and switch each associated function implemented by the UE from a first machine learning model associated with the first group to a second machine learning model associated with the second group based on the indication to switch.

Another apparatus for wireless communication at a UE is described. The apparatus may include means for identifying a set of groups, each group in the set of groups including a machine learning model for each of one or more functions implemented by the UE, each machine learning model corresponding to a condition in which each function is implemented by the UE, means for receiving an indication to switch from a first group to a second group in the set of groups based on a threshold change of the condition, and means for switching each associated function implemented by the UE from a first machine learning model associated with the first group to a second machine learning model associated with the second group based on the indication to switch.

A non-transitory computer-readable medium storing code for wireless communication at a UE is described. The code may include instructions executable by a processor to identify a set of groups, each group in the set of groups including a machine learning model for each of one or more functions implemented by the UE, each machine learning model corresponding to a condition in which each function is implemented by the UE, receive an indication to switch from a first group to a second group in the set of groups based on a threshold change of the condition, and switch each associated function implemented by the UE from a first machine learning model associated with the first group to a second machine learning model associated with the second group based on the indication to switch.

Some examples of the method, apparatuses, and non-transitory computer-readable medium described herein may further include operations, features, means, or instructions for transmitting an indication of the set of groups to a network entity to register the set of groups, where the indication to switch may be received based on the registering.

In some examples of the method, apparatuses, and non-transitory computer-readable medium described herein, the indication of the set of groups includes, for each model, a group identifier that may be unique to each group in the set of groups and a shared group identifier among one or more machine learning models define the group.

In some examples of the method, apparatuses, and non-transitory computer-readable medium described herein, the indication of the set of groups includes, for each machine learning model, an associated model or function identifier and the associated model or function identifier define the group as including the machine learning model and the associated model or function corresponding to the associated model or function identifier.

Some examples of the method, apparatuses, and non-transitory computer-readable medium described herein may further include operations, features, means, or instructions for receiving an indication of the set of groups from a network entity, where the identifying may be based on the indication of the set of groups.

Some examples of the method, apparatuses, and non-transitory computer-readable medium described herein may further include operations, features, means, or instructions for identifying, based on the indication of the set of groups, a group identifier for each machine learning model that may be unique to each group in the set of groups, where each group may be defined by a shared group identifier among one or more machine learning models.

Some examples of the method, apparatuses, and non-transitory computer-readable medium described herein may further include operations, features, means, or instructions for identifying, based on the indication of the set of groups, an associated model or function identifier for each model, where the associated model or function identifier define the group as including the machine learning model and the associated model or function corresponding to the associated model or function identifier.

In some examples of the method, apparatuses, and non-transitory computer-readable medium described herein, identifying the set of groups may include operations, features, means, or instructions for identifying a first list of machine learning models corresponding to a first function and a second list of machine learning models corresponding to a second function and identifying the first group based on a first machine learning model from the first list of machine learning models and the first machine learning model from the second list of machine learning models and identifying the second group based on a second machine learning model from the first list of machine learning models and the second machine learning model from the second list of machine learning models.

In some examples of the method, apparatuses, and non-transitory computer-readable medium described herein, the indication may be received in radio resource control (RRC) signaling or in a medium access control-control element (MAC-CE).

In some examples of the method, apparatuses, and non-transitory computer-readable medium described herein, identifying the set of groups may include operations, features, means, or instructions for identifying, based on a first field in the indication to switch, the indication to switch from the first group to the second group for a first set of functions implemented by the UE and identifying, based on a second field in the indication to switch, an indication to switch from a third group to a fourth group for a second set of functions implemented by the UE.

In some examples of the method, apparatuses, and non-transitory computer-readable medium described herein, the indication to switch indicates that the first group may be deactivated, that the second group may be activated, or both.

In some examples of the method, apparatuses, and non-transitory computer-readable medium described herein, the indication to switch may be received in a UE-specific downlink control information (DCI), in a group common DCI, or in a MAC-CE.

Some examples of the method, apparatuses, and non-transitory computer-readable medium described herein may further include operations, features, means, or instructions for determining that the function implemented by the UE according to a first machine learning model in the first group fails to satisfy a performance threshold and transmitting a report to a network entity indicating that the first group failed to satisfy the performance threshold, where the indication to switch may be based on the report.

Some examples of the method, apparatuses, and non-transitory computer-readable medium described herein may further include operations, features, means, or instructions for determining that implementing the function by the UE according to a second machine learning model in the second group satisfies the performance threshold, where the report identifies the second group as a preferred group.

In some examples of the method, apparatuses, and non-transitory computer-readable medium described herein, the function includes at least one of a channel state information (CSI) feedback function, a channel optimization function, a beam management function, a CSI-reference signal (RS) optimization function, a demodulation reference signal (DMRS) function, a physical layer function, a timing function, a synchronization function, a spatial function, a power management function, an interference management function, or a location function.

In some examples of the method, apparatuses, and non-transitory computer-readable medium described herein, the condition includes at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

A method for wireless communication at a network entity is described. The method may include identifying a set of groups for a UE, each group in the set of groups including a machine learning model for each of one or more functions implemented by the UE, each machine learning model corresponding to a condition in which each function is implemented by the UE, determining that the condition in which each function being implemented by the UE has changed at least a threshold change, and transmitting an indication for the UE to switch from a first group to a second group in the set of groups based on the threshold change of the condition.

An apparatus for wireless communication at a network entity is described. The apparatus may include a processor, memory coupled with the processor, and instructions stored in the memory. The instructions may be executable by the processor to cause the apparatus to identify a set of groups for a UE, each group in the set of groups including a machine learning model for each of one or more functions implemented by the UE, each machine learning model corresponding to a condition in which each function is implemented by the UE, determine that the condition in which each function being implemented by the UE has changed at least a threshold change, and transmit an indication for the UE to switch from a first group to a second group in the set of groups based on the threshold change of the condition.

Another apparatus for wireless communication at a network entity is described. The apparatus may include means for identifying a set of groups for a UE, each group in the set of groups including a machine learning model for each of one or more functions implemented by the UE, each machine learning model corresponding to a condition in which each function is implemented by the UE, means for determining that the condition in which each function being implemented by the UE has changed at least a threshold change, and means for transmitting an indication for the UE to switch from a first group to a second group in the set of groups based on the threshold change of the condition.

A non-transitory computer-readable medium storing code for wireless communication at a network entity is described. The code may include instructions executable by a processor to identify a set of groups for a UE, each group in the set of groups including a machine learning model for each of one or more functions implemented by the UE, each machine learning model corresponding to a condition in which each function is implemented by the UE, determine that the condition in which each function being implemented by the UE has changed at least a threshold change, and transmit an indication for the UE to switch from a first group to a second group in the set of groups based on the threshold change of the condition.

Some examples of the method, apparatuses, and non-transitory computer-readable medium described herein may further include operations, features, means, or instructions for transmitting an indication of the set of groups to the UE to register the set of groups.

In some examples of the method, apparatuses, and non-transitory computer-readable medium described herein, the indication of the set of groups includes, for each machine learning model, a group identifier that may be unique to each group in the set of groups and a shared group identifier among one or more machine learning models define the group.

In some examples of the method, apparatuses, and non-transitory computer-readable medium described herein, the indication of the set of groups includes, for each machine learning model, an associated model or function identifier and the associated model or function identifier define the group as including the machine learning model and the associated model or function corresponding to the associated model or function identifier.

Some examples of the method, apparatuses, and non-transitory computer-readable medium described herein may further include operations, features, means, or instructions for receiving an indication of the set of groups from the UE, where the identifying may be based on the indication of the set of groups.

Some examples of the method, apparatuses, and non-transitory computer-readable medium described herein may further include operations, features, means, or instructions for identifying, based on the indication of the set of groups, a group identifier for each machine learning model that may be unique to each group in the set of groups, where each group may be defined by a shared group identifier among one or more machine learning models.

Some examples of the method, apparatuses, and non-transitory computer-readable medium described herein may further include operations, features, means, or instructions for identifying, based on the indication of the set of groups, an associated model or function identifier for each model, where the associated model or function identifier define the group as including the machine learning model and the associated model or function corresponding to the associated model or function identifier.

In some examples of the method, apparatuses, and non-transitory computer-readable medium described herein, identifying the set of groups may include operations, features, means, or instructions for identifying a first list of machine learning models corresponding to a first function and a second list of machine learning models corresponding to a second function and identifying the first group based on a first machine learning model from the first list of machine learning models and the first machine learning model from the second list of machine learning models and identifying the second group based on a second machine learning model from the first list of machine learning models and the second machine learning model from the second list of machine learning models.

In some examples of the method, apparatuses, and non-transitory computer-readable medium described herein, the indication may be received in RRC signaling or in a MAC-CE.

In some examples of the method, apparatuses, and non-transitory computer-readable medium described herein, transmitting the indication to switch may include operations, features, means, or instructions for transmitting, in the indication to switch, a first field in indicating to switch from the first group to the second group for a first set of functions implemented by the UE and a second field indicating to switch from a third group to a fourth group for a second set of functions implemented by the UE.

In some examples of the method, apparatuses, and non-transitory computer-readable medium described herein, the indication to switch indicates that the first group may be deactivated, that the second group may be activated, or both.

In some examples of the method, apparatuses, and non-transitory computer-readable medium described herein, the indication to switch may be transmitted in a UE-specific DCI, in a group common DCI, or in a MAC-CE.

Some examples of the method, apparatuses, and non-transitory computer-readable medium described herein may further include operations, features, means, or instructions for receiving a report from the UE indicating that the function implemented by the UE according to a first machine learning model in the first group fails to satisfy a performance threshold, where the indication to switch to the second group may be based on the report.

Some examples of the method, apparatuses, and non-transitory computer-readable medium described herein may further include operations, features, means, or instructions for determining, based on the report, that the UE implementing the function according to a second machine learning model in the second group satisfies the performance threshold, where the indication to switch to the second group may be transmitted based on the report.

In some examples of the method, apparatuses, and non-transitory computer-readable medium described herein, the function includes at least one of a CSI feedback function, a channel optimization function, a beam management function, a CSI-RS optimization function, a DMRS function, a physical layer function, a timing function, a synchronization function, a spatial function, a power management function, an interference management function, or a location function.

In some examples of the method, apparatuses, and non-transitory computer-readable medium described herein, the condition includes at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

A method for wireless communication at a UE is described. The method may include identifying a set of groups, each group in the set of groups including a machine learning model for each of one or more functions implemented by the UE, each machine learning model corresponding to a condition in which each function is implemented by the UE, determining that a function implemented by the UE according to a first machine learning model in a first group fails to satisfy a performance threshold, and transmitting a report to a network entity indicating that the first group failed to satisfy the performance threshold.

An apparatus for wireless communication at a UE is described. The apparatus may include a processor, memory coupled with the processor, and instructions stored in the memory. The instructions may be executable by the processor to cause the apparatus to identify a set of groups, each group in the set of groups including a machine learning model for each of one or more functions implemented by the UE, each machine learning model corresponding to a condition in which each function is implemented by the UE, determine that a function implemented by the UE according to a first machine learning model in a first group fails to satisfy a performance threshold, and transmit a report to a network entity indicating that the first group failed to satisfy the performance threshold.

Another apparatus for wireless communication at a UE is described. The apparatus may include means for identifying a set of groups, each group in the set of groups including a machine learning model for each of one or more functions implemented by the UE, each machine learning model corresponding to a condition in which each function is implemented by the UE, means for determining that a function implemented by the UE according to a first machine learning model in a first group fails to satisfy a performance threshold, and means for transmitting a report to a network entity indicating that the first group failed to satisfy the performance threshold.

A non-transitory computer-readable medium storing code for wireless communication at a UE is described. The code may include instructions executable by a processor to identify a set of groups, each group in the set of groups including a machine learning model for each of one or more functions implemented by the UE, each machine learning model corresponding to a condition in which each function is implemented by the UE, determine that a function implemented by the UE according to a first machine learning model in a first group fails to satisfy a performance threshold, and transmit a report to a network entity indicating that the first group failed to satisfy the performance threshold.

Some examples of the method, apparatuses, and non-transitory computer-readable medium described herein may further include operations, features, means, or instructions for receiving, based on the report, an indication to switch from the first group to a second group in the set of groups and switching the function implemented by the UE from a first machine learning model associated with the first group to a second machine learning model associated with the second group based on the indication to switch.

Some examples of the method, apparatuses, and non-transitory computer-readable medium described herein may further include operations, features, means, or instructions for transmitting an indication of the set of groups to the network entity to register the set of groups.

Some examples of the method, apparatuses, and non-transitory computer-readable medium described herein may further include operations, features, means, or instructions for receiving an indication of the set of groups from the network entity, where the identifying may be based on the indication.

Some examples of the method, apparatuses, and non-transitory computer-readable medium described herein may further include operations, features, means, or instructions for determining that implementing the function by the UE according to a second machine learning model in a second group satisfies the performance threshold, where the report identifies the second group as a preferred group.

A method for wireless communication at a network entity is described. The method may include identifying a set of groups for a UE, each group in the set of groups including a machine learning model for each of one or more functions implemented by the UE, each machine learning model corresponding to a condition in which each function is implemented by the UE and receiving a report from the UE indicating that a first group in the set of groups failed to satisfy a performance threshold.

An apparatus for wireless communication at a network entity is described. The apparatus may include a processor, memory coupled with the processor, and instructions stored in the memory. The instructions may be executable by the processor to cause the apparatus to identify a set of groups for a UE, each group in the set of groups including a machine learning model for each of one or more functions implemented by the UE, each machine learning model corresponding to a condition in which each function is implemented by the UE and receive a report from the UE indicating that a first group in the set of groups failed to satisfy a performance threshold.

Another apparatus for wireless communication at a network entity is described. The apparatus may include means for identifying a set of groups for a UE, each group in the set of groups including a machine learning model for each of one or more functions implemented by the UE, each machine learning model corresponding to a condition in which each function is implemented by the UE and means for receiving a report from the UE indicating that a first group in the set of groups failed to satisfy a performance threshold.

A non-transitory computer-readable medium storing code for wireless communication at a network entity is described. The code may include instructions executable by a processor to identify a set of groups for a UE, each group in the set of groups including a machine learning model for each of one or more functions implemented by the UE, each machine learning model corresponding to a condition in which each function is implemented by the UE and receive a report from the UE indicating that a first group in the set of groups failed to satisfy a performance threshold.

Some examples of the method, apparatuses, and non-transitory computer-readable medium described herein may further include operations, features, means, or instructions for transmitting, based on the report, an indication for the UE to switch from the first group to a second group in the set of groups, where the function implemented by the UE may be switched from a first machine learning model associated with the first group to a second machine learning model associated with the second group.

Some examples of the method, apparatuses, and non-transitory computer-readable medium described herein may further include operations, features, means, or instructions for receiving an indication of the set of groups from the UE to register the set of groups, where the identifying may be based on the indication.

Some examples of the method, apparatuses, and non-transitory computer-readable medium described herein may further include operations, features, means, or instructions for transmitting an indication of the set of groups to the UE.

Some examples of the method, apparatuses, and non-transitory computer-readable medium described herein may further include operations, features, means, or instructions for determining that implementing the function by the UE according to a second machine learning model in a second group satisfies the performance threshold, where the report identifies the second group as a preferred group.

Some examples of the method, apparatuses, and non-transitory computer-readable medium described herein may further include operations, features, means, or instructions for determining, based on the report, that a function implemented by the UE according to a first machine learning model in the first group fails to satisfy the performance threshold.

### BRIEF DESCRIPTION OF THE DRAWINGS

FIG. 1 illustrates an example of a wireless communications system that supports model relation and unified switching, activation and deactivation in accordance with one or more aspects of the present disclosure.

FIG. 2 illustrates an example of a wireless communications system that supports model relation and unified switching, activation and deactivation in accordance with one or more aspects of the present disclosure.

FIG. 3 illustrates an example of a grouping configuration that supports model relation and unified switching, activation and deactivation in accordance with one or more aspects of the present disclosure.

FIGS. 4A and 4B illustrate examples of a signaling configuration that supports model relation and unified switching, activation and deactivation in accordance with one or more aspects of the present disclosure.

FIGS. 5 and 6 show block diagrams of devices that support model relation and unified switching, activation and deactivation in accordance with one or more aspects of the present disclosure.

FIG. 7 shows a block diagram of a communications manager that supports model relation and unified switching, activation and deactivation in accordance with one or more aspects of the present disclosure.

FIG. 8 shows a diagram of a system including a device that supports model relation and unified switching, activation and deactivation in accordance with one or more aspects of the present disclosure.

FIGS. 9 and 10 show block diagrams of devices that support model relation and unified switching, activation and deactivation in accordance with one or more aspects of the present disclosure.

FIG. 11 shows a block diagram of a communications manager that supports model relation and unified switching, activation and deactivation in accordance with one or more aspects of the present disclosure.

FIG. 12 shows a diagram of a system including a device that supports model relation and unified switching, activation and deactivation in accordance with one or more aspects of the present disclosure.

FIGS. 13 through 16 show flowcharts illustrating methods that support model relation and unified switching, activation and deactivation in accordance with one or more aspects of the present disclosure.

### DETAILED DESCRIPTION

A channel state information (CSI) feedback function may be used to manage the performance of the wireless channel. The CSI feedback function includes the network entity and a user equipment (UE) exchanging and interpreting information related to the physical channel to improve throughput and configuration decisions supporting wireless communications. Another example of a function includes beam management function where the network entity and UE again exchange and interpret information related to beam selection and management (e.g., to support beamformed communications). Wireless communications may occur under different conditions, such as under different Doppler conditions, under different angular speed conditions, under different delay spread conditions, under different UE movement conditions, among others. Accordingly, the wireless network may define various machine learning models (e.g., artificial intelligence (AI) models, adaptive feedback models, or any other technique to evaluate input information within a given context and render a decision, output, that improves the corresponding function) for a given function, where each machine learning model corresponds to the technique, formulation, procedure, process, and the like, that a function utilizes under a given condition.

For example, a CSI feedback function may be implemented within the UE and the network entity during a high Doppler data condition using a first machine learning model that is different from a second (or third) machine learning model used for the CSI feedback function implemented during a medium or low Doppler data condition. For example, a CSI feedback function may be implemented within the UE and the network entity during an indoor scenario (e.g., large delay spread, non-lie-of-sight (NLOS) condition) using a first machine learning model that is different from a second (or third) machine learning model used for the CSI feedback function implemented during an outdoor scenario (e.g., a medium or low delay spread condition or line-of-sight (LOS) condition). Accordingly, each function implemented within the UE may learn or otherwise configure one or more machine learning models to be implemented by the function where different models correspond to different conditions under which the function is performed. However, wireless networks use individual signaling to configure, activate, or deactivate a given model for each function. That is, for each model registered within conventional networks, individual signaling is used to active and deactivate the machine learning model. When multiple functions are being implemented within the wireless network (e.g., by the individual network entity and UE) and a change in the condition occurs, separate signaling may be used to update the machine learning models being used for each function.

Accordingly, the described techniques relate to improved methods, systems, devices, and apparatuses that support model relation and unified switching, activation and deactivation. For example, the described techniques provide for grouping machine learning models from different functions according to the condition of the wireless network and wireless environment. For example, a UE may identify or otherwise determine a set of groups. Each group may generally include a machine learning model for one or more functions implemented by the UE and network entity (e.g., a first model for a first function, a second model for a second function, and so forth). In each group, the machine learning models included in the group for the different functions may each correspond to or otherwise be associated with a specific condition (e.g., a given Doppler condition, delay spread condition, NLOS or LOS, indoor or outdoor, network feature including antenna layout and beamforming schemes, and the like). In some examples the UE may define the groupings with the network entity, the network entity may define the groupings and notify the UE of the groupings, or the network entity and UE may cooperate to define the groupings. This may enable the network entity to rely on unified signaling techniques where the network switches the UE from a first group to a second group based on a change in the condition. This may enable the network to switch from the current group corresponding to the first condition (e.g., the old condition) to a second group corresponding to a second condition (e.g., the new condition) for each function being implemented in the wireless network. That is, registering the models for different functions but corresponding to a given condition into groups may enable the network to configure, activate, and deactivate models for multiple functions based on updated conditions within the network.

Additionally, or alternatively, when one or more machine learning models (e.g., a first machine learning model) within a group for a function fails to satisfy performance thresholds, this may indicate that the condition associated with the group for the corresponding function may have changed such that the current group of machine learning models are incorrect under the changed condition. Accordingly, the UE may transmit a report to the network that carries or otherwise conveys an indication that the group (e.g., identifying the specific group, the model within the group, or both) has failed to satisfy the performance threshold(s). The network entity may optionally, in response to the group failure report, transmit a switching indication directing the UE to switch from the current group (e.g., a first group) to a different group (e.g., a second group) that corresponds more closely to the changed condition.

Aspects of the disclosure are initially described in the context of wireless communications systems. Aspects of the disclosure are further illustrated by and described with reference to apparatus diagrams, system diagrams, and flowcharts that relate to model relation and unified switching, activation and deactivation.

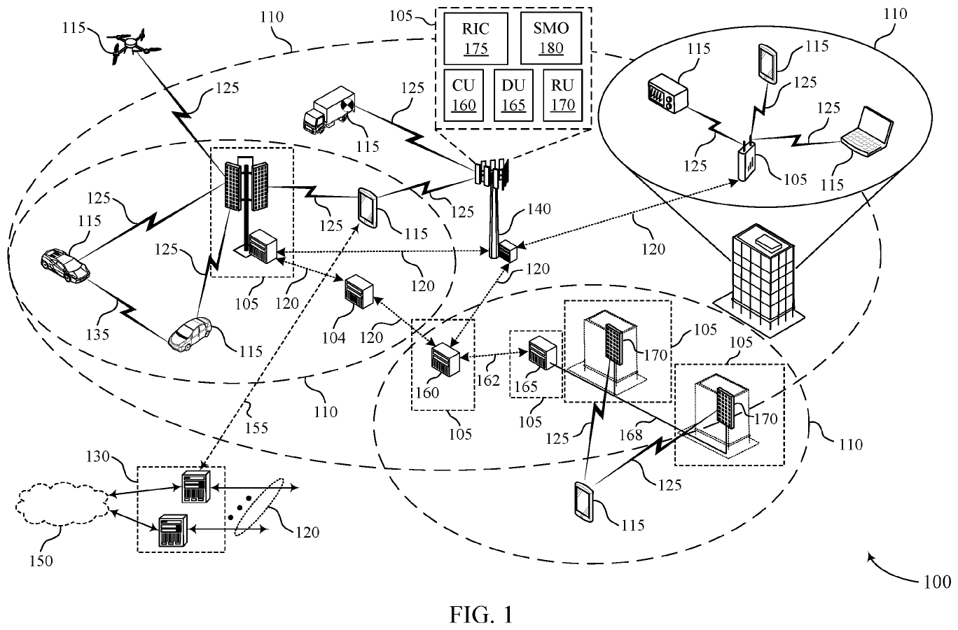

FIG. 1 illustrates an example of a wireless communications system 100 that supports model relation and unified switching, activation and deactivation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support model relation and unified switching, activation and deactivation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may identify a set of groups, each group in the set of groups comprising a machine learning model for each of one or more functions implemented by the UE 115, each machine learning model corresponding to a condition in which each function is implemented by the UE 115. The UE 115 may receive an indication to switch from a first group to a second group in the set of groups based at least in part on a threshold change of the condition. The UE 115 may switch each associated function implemented by the UE 115 from a first machine learning model associated with the first group to a second machine learning model associated with the second group based at least in part on the indication to switch.

A network entity 105 may identify a set of groups for a UE 115, each group in the set of groups comprising a machine learning model for each of one or more functions implemented by the UE 115, each machine learning model corresponding to a condition in which each function is implemented by the UE 115. The network entity 105 may determine that the condition in which each function being implemented by the UE 115 has changed at least a threshold change. The network entity 105 may transmit an indication for the UE 115 to switch from a first group to a second group in the set of groups based at least in part on the threshold change of the condition.

A UE 115 may identify a set of groups, each group in the set of groups comprising a machine learning model for each of one or more functions implemented by the UE 115, each machine learning model corresponding to a condition in which each function is implemented by the UE 115. The UE 115 may determine that a function implemented by the UE 115 according to a first machine learning model in a first group fails to satisfy a performance threshold. The UE 115 may transmit a report to a network entity 105 indicating that the first group failed to satisfy the performance threshold.

A network entity 105 may identify a set of groups for a UE 115, each group in the set of groups comprising a machine learning model for each of one or more functions implemented by the UE 115, each machine learning model corresponding to a condition in which each function is implemented by the UE 115. The network entity 105 may receive a report from the UE 115 indicating that a first group in the set of groups failed to satisfy a performance threshold.

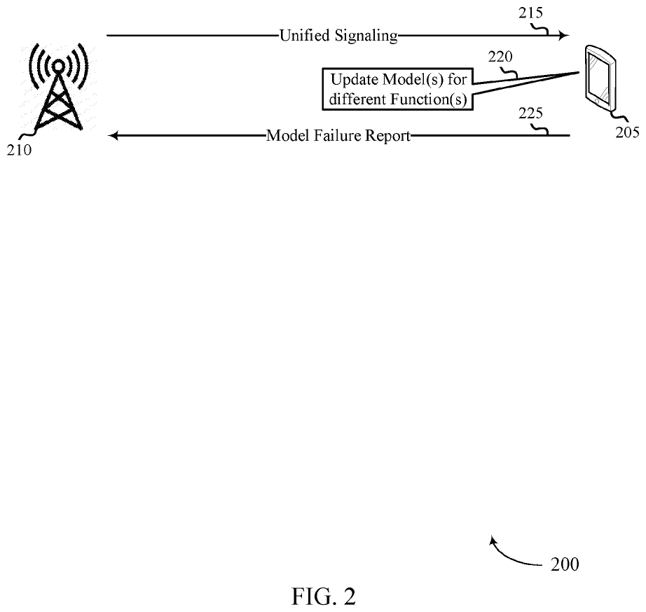

FIG. 2 illustrates an example of a wireless communications system 200 that supports model relation and unified switching, activation and deactivation in accordance with one or more aspects of the present disclosure. Wireless communications system 200 may implement aspects of wireless communication system 100. Wireless communications system 200 may include UE 205 and network entity 210, which may be examples of the corresponding devices described herein.

Wireless networks generally utilize various functions to monitor, manage, and improve network performance. Functions may be implemented by UE 205 and network entity 210 related to the physical channel (e.g., the wireless channel) performance, traffic patterns, spatial management, temporal management, and the like. Each function is generally performed utilizing a model. A model in this context broadly refers to the specific technique, rule, process, procedure, and so forth, in which an input is received and encoded (e.g., interpreted and conveyed), the encoded signal is exchanged within the wireless network, the encoded signal is decoded (e.g., recovered and interpreted) and provides an output (e.g., a decision, parameter, configuration, and so forth) utilized within the wireless network. References to a model may include any machine learning model, such as using AI modelling techniques. Examples of such functions may include, but are not limited to, a CSI feedback function, a channel optimization function, a beam management function, a CSI-RS transmission and channel estimation function, a DMRS channel estimation function, a physical layer function, a timing function, a synchronization function, a spatial function, a power management function, an interference management function, a location function, or any other function implemented within the wireless network.

The wireless network may also experience various conditions. Such conditions may generally define the environment of the network, such as the environment in which a specific function is being performed. The condition may be applicable network wide (e.g., relevant to all nodes within the network), applicable to a specific node (e.g., applicable UE 205), applicable to a communication pair (e.g., between a UE and network entity, between two UEs, between two network entities), applicable to a link (e.g., a specific wireless channel or port), and the like. Examples of such conditions may include, but are not limited to, a Doppler condition, an angular speed condition, a delay spread condition, indoor or outdoor condition, a LOS or NLOS condition, a travel direction condition, a travel speed condition, an antenna layout condition, a digital/analog precoding condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, a change in one or more of conditions, or any other conditions under which the wireless network operates.

Broadly, each model utilized by the various functions implemented with the network may change depending on the condition of the wireless network. For example, a first model used for a function under a first condition may be less optimal under a second condition. Accordingly, the model used to implement a function under the first condition may be different from the model used to implement the function under the second condition. The differences between the models used to perform the same function under different conditions may be small (e.g., adjusting one or more variables, parameters, weighting factors), substantial (e.g., using models having completely different approaches), or anywhere in between (e.g., considering additional or fewer features). Accordingly, the network may configure each model configured to support the function, with the differences between the models based on the condition of the network.

For example, a family of models may be trained, tested, and compiled. Then, the models are registered with the network with corresponding model IDs. Each model is designed or developed for a certain set of scenarios (e.g., conditions). Additional examples of such conditions include urban micro vs urban macro vs indoor hotspot conditions, various bandwidth configuration conditions, various payload to fit different UE location (cell center UE can report high payload for high resolution CSI, cell-edge may have to report low payload for low resolution due to coverage issue) conditions, various antenna setup (e.g., antenna/transmit/receive chain, TxRU, layout (4×4, 2×8,etc.) and antenna element to TxRU mapping.

As one example, a CSI feedback function may be report the CSI of the wireless channel, so network entity 210 knows the proper precoder, rank, MCS and proper resource allocation for downlink transmissions to increase the throuput. In some networks, the CSI reporting configuration may include the UE using a sequence of bits to report a precoding matrix indicator (PMI). For example, the CSI reporting configuration may include a codebook, which is used as a PMI dictionary (e.g., table or generation method of each component of the PMO codebook) from which the UE report its best codewords (e.g., based on channel performance characteristics measured using CSI-RS). A model approach (e.g., AI based CSI feedback) may replace the codebook with a CSI encode and decoder. The encoder in this context may be analogous to the PMI searching algorithm and the decoder may be analogous to the PMI codebook used to translate the CSI reporting bits to a PMI codeword. The output of the decoder may include a downlink channel matrix (H) (either the raw or whitened downlink channel filtered based on the interference measurement), transmit covariance matrix, downlink precoders (V), interference covariance matrix (Rₙₙ), a rank indicator (RI), PMI, channel quality indicator (CQI), or an indication for the full channel. In this CSI feedback function example, UE 205 may measure or otherwise quantity an aspect of channel performance (e.g., eigenvectors on each subband for one or more layers), encode that information (e.g., as H, V, Rₙₙ, and the like) for conveying to the network (e.g., determine what and how to indicate the information), which may decode the information to provide an output designed to maintain or improve wireless communications within the network.

Additional examples of such functions may include a beam management function used to predict the beam to be used in future time instances or in the spatial domain or other relevant information. This may include network entity 210 transmitting N CSI-RS ports via N beams {b1,b2,b3, . . . , bN}. UE 205 may use the CSI-RS transmissions to predict, identify, or otherwise determine the best beam to be used for future communications (e.g., based on its current trajectory, which may be a condition in this example). For example, UE 205 may measure the power during its current slot t0 {P1(t0), P2(t0), . . . PN(t)} and use this information as inputs to the AI model.

Alternatively, UE 205 may use the received signal of the N ports as an input to the model (e.g., {y1(t0), y2(t0), . . . , yN(t0)} as the input). UE 205 may predict, identify, or otherwise determine the power, the dominant beam, or both, during slot t0+t) or predicting the power of the N beams during slot t0+t. For the spatial beam prediction function (e.g., functions dealing with beam management, spatial features, and the like), this may include UE 205 using a set of beams B as an input to the model and obtaining one or more dominant beams a set of beams A as the output of the model. The set of beams B may be a wider beam relative to the set of beams A or the set of beams B may be a subset of the set of beams A.

Another function may include a CSI-RS optimization and channel estimation function. For example, network entity 210 may transmit CSI-RS using a reduced density (e.g., using fewer resources, resulting in fewer instances of the CSI-RS). The reduced density may be achieved via a sparse pattern (e.g., only using L ports out of Nt ports are used for CSI-RS transmissions, transmitting on only K resource blocks (RBs) out of N RBs, and so forth). An AI model approach for CSI-RS optimization (e.g., reduced density) may be based on an AI based cover code that multiplexes Nt ports on L resource elements (REs) per RB and the CSI-RS are transmitted during only K RBs out of N RBs. UE 205 may use an NN based channel estimation model to recover all Nt ports on all the N RBs. A demodulation reference signal (DMRS) optimization function may use an NN based channel estimation model to recover the channel on all ports and on all REs.

Accordingly, the wireless network may define various models to evaluate input information within a given context and render a decision, such as providing an output, that improves the corresponding function. After training, the family of models are registered in the network, with each model having a different identifier (model ID).

However, wireless networks use individual signaling to configure, activate, or deactivate a given model for each function. For example, the network may deploy (e.g., activate) a model by signaling the model ID to the UE where the UE then accesses a model server (e.g., a server or function storing registered models) to download the model for implementation for a function). Each function implemented within the wireless network may therefore have a family of models registered. For each model registered within conventional networks, individual signaling is used to active and deactivate the model (e.g., based on the model ID). When multiple functions are being implemented within the wireless network (e.g., by the individual network entity and UE) and a change in the condition occurs, separate signaling may be used to update the models being used for each function. This approach is resource usage intense and inefficient.

Accordingly, the techniques described herein relate to improved methods, systems, devices, and apparatuses that support model relation and unified switching, activation and deactivation. For example, the described techniques provide for grouping models (e.g., machine learning, AI, or any other modeling from different functions according to the condition of the wireless network.

For example, UE 205 and network entity 210 may identify or otherwise determine a set of groups. Each group may generally include a model for one or more functions implemented by UE 205 and network entity 210 (e.g., a first model for a first function, a second model for a second function, and so forth). In each group, the models included in the group for the different functions may each correspond to or otherwise be associated with a specific condition (e.g., a given Doppler data condition, network feature, and the like).

In some examples UE 205 may define and register the groupings with the network. For example, the model grouping across functions features described herein may generally provide for UE 205 defining and reporting the model grouping/relation to network entity 210. For example, UE 205 may transmit or otherwise provide an indication of the set of groups to network entity 210 to register the set of groups (e.g., to register the models with the model server). There are one or more models trained for a function (e.g., under different conditions). When registering each model for the function (e.g., the family of models), UE 205 may include information (e.g., such as a group ID) with the model.

One example may include UE 205 including, for each model, a group identifier (e.g., the group ID) that is unique to each group in the set of groups. In this manner, a shared group identifier among models may define the group. That is, registered models having the same or shared group ID may indicate that these models are being registered as a group in the set of groups. This means that models within the same group are related to each other, and they are trained and to be deployed or activated for the same scenario or condition or configuration. Models within each group may be updated (e.g., modified, added, deleted, enabled, disabled) based on registering the updated model using the same group ID. As one non-limiting example, when registering a model with network entity 210, UE 205 may provide the group ID with the model. The model(s) with the same group ID are considered (e.g., grouped) into the same group. If the group ID of a model (e.g., for a given model ID) is set to none or blank, this may signal that the registered model is not associated with any other models (e.g., is not to be included in a group). More particularly, the indication may include a CSI feedback (CSF) model 1 registered to group 1, a CSF model 2 registered to group 2; reference signal (RS) model 1 registered to group 1, a RS model 2 registered to group 2, and so forth. In this example, the CSF model 1 and RS model 1 are associated with each other (e.g., form a first group in the set of groups), while CSF model 2 and RS model 2 are also associated with each other, but in a different group (e.g., form a second group in the set of groups).

Another example may include UE 205 including, for each model, an associated model or function identifier. In this manner, the associated model or function identifier may define the group as including the model as well as the associated model or function corresponding to the associated model or function identifier. For example, when registering a model with network entity 210, UE 205 may provide an associated model ID and/or application ID. If a model is neither registered with an associated model nor registered as an associated model for another model, it may not be tied to any other models (e.g., may not be included in any groups). More particularly, the indication may include a CSF model 1 associated with RS model 1 and a CSF model 2 associated with RS model 2. This means that CSF model 1 and RS model 1 may be associated to each other (e.g., CSF model 1 to RS model 1 included in a first group), while CSF model 2 and RS model 2 may be associated with each other (e.g., included in a second group).

In other examples, network entity 210 may define and register the groupings and notify UE 205 of the groupings. For examine, network entity 210 may transmit or otherwise provide (and UE 205 may receive or otherwise obtain) an indication of the set of groups. For example, network entity 210 may (e.g., alone or in cooperation with other nodes within the wireless network, functions within the core network, or both) configured, identify or otherwise determine the groupings/relationships of the models for UE 205. UE 205 may identify the set of groups based on the indication of the set of groups from network entity 210.

One example may include network entity 210 including a group identifier for each model that is unique to each group in the set of groups. In this manner, each group may again be defined by a shared or common (e.g., the same) group identifier among the models. That is, network entity 210 may configure the group identifier or associated model to UE 205. Network entity 210 may configure the group ID(s) or associated model(s) to UE 205 using RRC signaling or in a medium access control-control element (MAC-CE). For example, network entity 210 may configure the group ID or associated model ID to UE 205 via RRC configuration or MACCE. In some examples, network entity 210 may use MAC-CE to update the grouping/association.

Another example may include network entity 210 including an associated model or function identifier for each model. In this manner, each group may again be defined as the model and the associated model or function corresponding to the associated model or function identifier.

Another example may include network entity 210 including a first list of models for a first function and a second list of models for a second function. For example, the MAC-CE may contain a cell/carrier ID, a first list of model IDs for function 1 and a second list of corresponding associated model IDs of function 2, and a third list of associated model IDs of function 3. There may be a 1-to-1 mapping (1-to-1-to-1 mapping) among the models based on their orders in the lists, meaning that the mapped models are grouped or associated. For example, The first group may be defined as including the first model from the first list for the first function, the first model from the second list for the second function, and the first model from the third list for the third function. The second group may be defined as including the second models from the first list, the second list and the third list, respectively. Lastly the third group may be defined as including the third models from the first list, the second list and the third list, respectively. The signaling can also be used by UE 205 to transmit an uplink MAC-CE to indicate the grouping information to network entity 210.

In some examples, this may additionally, or alternatively, enable the network to rely on unified signaling techniques where the network switches UE 205 from a first group to a second group based on a change in the condition. For example, network entity 210 may transmit or otherwise provide (and UE 205 may receive or otherwise obtain) unified signaling 215. Unified signaling 215 may be configured to carry or otherwise convey an indication for UE 205 to switch from a first group to a second group in the set of groups. In some aspects, the indication to switch may be provided in response to threshold change of the condition. That is, network entity 210 may identify or otherwise determine that the condition has changed within the wireless network, for UE 205, or both, and transmit the indication to switch from the first group to the second group in the set of groups.

Accordingly, at 220 UE 205 may switch each associated function implemented by UE 205 from a first model associated with the first group to a second model associated with the second group. As one non-limiting example, UE 205 may be performing, participating in, or otherwise implementing two functions according to the first group. The first group may include a model corresponding to the first function and another model corresponding to the second function. The second group may include a second model for the first function and a second model for the second function. Again, the groups may be based on the condition such that the models in the first group may be for performing the two functions under a first condition and the models in the second group may be for performing the two functions under a second condition. The two functions may be performed under a current condition. Based on the change in the current condition (e.g., from the first condition to the second condition), network entity 210 may use unified signaling 215 to switch UE 205 from using the models in the first group corresponding to the current condition to using the models in the second group corresponding to the changed condition (e.g., the second condition). That is, registering the models for different functions but corresponding to a given condition into groups may enable the network to configure, activate, and deactivate models for multiple functions based on updated conditions within the network using unified signaling 215. Further, additional functions may also be configured, activated, or deactivated using the unified signaling 215. For example, a grouping of models for functions 3 and 4 may be defined, such that a second field in the unified signaling 215 may be used to switch the groups defined under functions 3 and 4.

Additionally, or alternatively, aspects of the techniques described herein may include model failure reporting 225. For example, UE 205 may detect, identify, or otherwise determine that a function being implemented by UE 205 according to a first model in the first group has failed to satisfy a performance threshold. For example, UE 205 may be implementing the function using the first group, which means the implementing each function according to the associated model in the first group. However, UE 205 may determine that at least one of the models is outputting results that are not improving wireless communications (e.g., failing to output results that satisfy various performance criteria). This may indicate that the condition has changed, at least to some degree, within the wireless network. As the changed condition no longer corresponds to the model(s) included in the first group, this may indicate that a change in the active group(s) from the set of groups may be warranted. Accordingly, UE 205 may transmit or otherwise provide a report to network entity 210 indicating that the first group has failed to satisfy the performance threshold.

In some examples, model failure reporting 225 may identify that a preferred group (e.g., may indicate that UE 205 is requesting to be switched from the first group to the second group). Accordingly, UE 205 may report a group model failure event, and in some examples further indicate the suggested group of models to be switched to. In the report (e.g., in model failure reporting 225), UE 205 may report a first signaling or field indicating the group model failure, wherein the signaling has one or more fields and each field is for an function group. For example, an indication may include an indication of the models for a first function and a second function that are grouped into the first group and the second group. The indication may use the first field to indicate whether or not the current group(s) is/are in failure. When models for third and fourth functions are grouped into a third group and a fourth group, respectively, UE 205 may use a second field to indicate whether or not the current model group for the third function and the fourth function are in failure. In the model failure reporting 225, UE 205 may report a second field or indication indicating the suggested new group, wherein the signaling has one or more fields and each field is for a group. For example, model group 1 is currently used for function 1 and function 2. The signaling may use the first field to indicate a preference for the second for the first and second functions. For example, a third group currently being used for functions three and four, may use a second field of the signaling to indicate a preference to switch to a fourth group for the third and fourth functions. If a field in the signaling corresponding to the current group is empty or otherwise set to a (pre)configured value, this may indicate that there is no model failure of the current group.

It is to be understood that different aspects of the techniques described herein may be performed alone or in combination. For example, grouping identification and configuration/reporting may be performed separate from or in combination with the unified signaling techniques, the model failure reporting techniques, or both. Similarly, the unified signaling techniques may be performed separate from or in combination with the grouping identification and configuration/reporting techniques, the model failure reporting techniques, or both. Lastly, the model failure reporting techniques may be performed separate from or in combination with the grouping identification and configuration/reporting techniques, the unified signaling techniques, or both. In some examples, the group model failure report may happen before group model switching. This means that the gNB may perform the switching decision and transmit switching command per group model failure report.

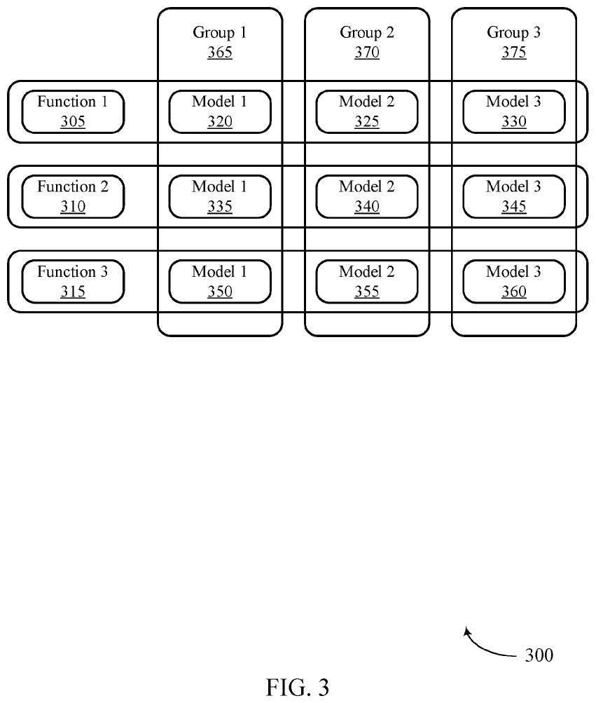

FIG. 3 illustrates an example of a grouping configuration 300 that supports model relation and unified switching, activation and deactivation in accordance with one or more aspects of the present disclosure. Grouping configuration may implement aspects of wireless communication system 100 or wireless communication system 200. Aspects of grouping configuration may be implemented at or by a UE or network entity, which may be examples of the corresponding devices described herein.

As discussed above, aspects of the techniques described herein provide for model grouping across functions according to a shared condition. That is, the UE and network entity may identify or otherwise determine a set of groups, where each group in the set of groups includes model(s) for each function implemented by the UE. Each model may correspond to the condition in which the function is implemented. Such model grouping techniques may support unified signaling techniques, model failure reporting techniques, both techniques, or neither techniques.

Grouping configuration 300 illustrates a non-limiting example of a set of groups formed according to the techniques described herein. According to grouping configuration 300, a UE may implement three functions by way of example only. For example, the UE may implement a first function 305, a second function 310, and a third function 315. Each function may be associated with a family of models. The first function 305 may be associated with model 320, with model 325, and with model 330. The second function 310 may be associated with model 335, with model 340, and with model 345. The third function 315 may be associated with model 350, with model 355, and with model 360. As discussed above, each model within a family of models for a function may corresponding to a different condition under which the function is implemented.

Accordingly, the techniques described herein provide for grouping models from different functions, but corresponding to a condition, into groups that may then be activated or deactivated using a single signal (e.g., unified signaling techniques). For example, a first group 365 in the set of groups may include model 320 for the first function 305, model 335 for the second function 310, and model 350 for the third function 315. A second group 370 in the set of groups may include model 325 for the first function 305, model 340 for the second function 310, and model 355 for the third function 315. A third group 375 in the set of groups may include model 330 for the first function 305, model 345 for the second function 310, and model 360 for the third function 315.

Thus, the first group 365 may be activated for the UE using unified signaling techniques. When the conditions change for the wireless network, the unified signaling techniques may be used to switch the UE from the first group 365 to the second group 370 (or to some other group). When one or more models within the first group 365 fails to satisfy a performance threshold, the model failure reporting techniques may be used to report the failed model (e.g., on a group basis). This may result in the group having the failed model simply being deactivated by the UE and network or may result in the unified signaling techniques being applied to switch the UE and network to a different group.

Accordingly, the UE, network entity, or both, may determine a model grouping (e.g., a relation or association), may receive a unified (common) signaling to trigger group switching, activation or deactivation switching models of multiple functions with a single indication. The UE may also report a unified signaling for model failure reporting or performance monitoring. Models for different functions (e.g., CSF, beam management, beam prediction, CSI-RS optimization, DMRS optimization, and so forth) are grouped/correlated together. Models in the same group are trained with data having similar statistics (e.g., under the same condition). The unified signaling techniques may enable a single (common) command being used to trigger switching/activation/deactivation of the grouped function models. For example, when the current group includes {CSF model 1, beam management model 1, CSI-RS model 1}, a single signaling may be used to switch the UE to another group of models {CSF model2, beam management model 2, CSI-RS model 2} rather than using three separate signals each for each function.

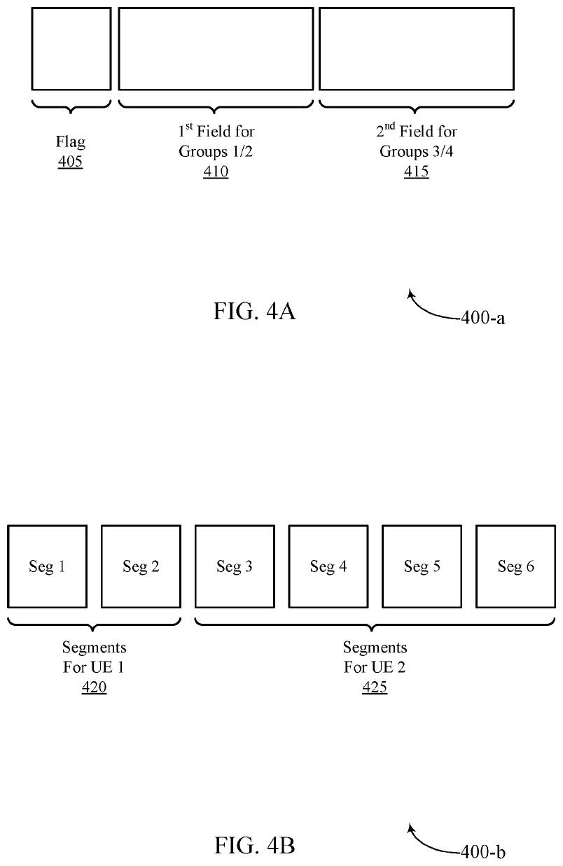

FIGS. 4A and 4B illustrate examples of a signaling configuration 400 that supports model relation and unified switching, activation and deactivation in accordance with one or more aspects of the present disclosure. Signaling configuration 400 may implement aspects of wireless communication system 100, wireless communication system 200, or grouping configuration 300. Aspects of signaling configuration 400 may be implemented at or by a UE or network entity, which may be examples of the corresponding devices described herein.

As discussed above, aspects of the techniques described herein provide for model grouping across functions according to a shared condition. That is, the UE and network entity may identify or otherwise determine a set of groups, where each group in the set of groups includes model(s) for each function implemented by the UE. Each model may correspond to the condition in which the function is implemented. Such model grouping techniques may support unified signaling techniques, model failure reporting techniques, both techniques, or neither techniques. Signaling configuration 400 illustrates examples of the unified signaling techniques according to the techniques described herein.

That is, the network entity may transmit an indication to switch from the first group to the second group in the set of groups. The indication may be provided, at least to some degree, based on a change in the condition under which the functions are being performed. For example, the identification of the set of groups in the indication to switch may include one or more fields corresponding to differently associated groups and functions. As one non-limiting example, this may include a first field int eh indication to switching indicating for the UE to switch from the first group to the second group for a set of functions (e.g., a first set of functions) being implemented by the UE. In some examples, the indication to switch may also include a second field used to identify an indication to switch from a third group to a fourth group for a second set of functions being implemented by the UE. In some examples, the indication to switch may include a flag, field, bit, and the like indicating whether the group(s) are being activated or deactivated. In some examples, the unified signaling may be communicated in a UE-specific DCI, a group common DCI, or in a MAC-CE.

Referring first to signaling configuration 400-a of FIG. 4A, a dedicated field may be included in a UE-specific DCI. The DCI may be either a downlink DCI (e.g., DCI 1_x) or an uplink DCI (e.g., DCI 0_x). A dedicated segment may be used for group switching. The dedicated segment may contain one or more fields, each field being for switching groups under a function group. For example, models for function 1 and function 2 may be grouped into group 1 and group 2. The indication to switch may use a first field 410 of the group switching segmentation for group-based switching for functions 1 and 2. The models for function 3 and function 4 may be grouped into group 3 and group 4. The indication to switch may use a second field 415 of the group switching segmentation for group-based model switching of functions 3 and 4. In some examples, this approach may be applied to group activation or deactivation, a dedicated bit (e.g., flag 405) may be added for (e.g., to signal) activation or deactivation the corresponding group in each field. For example, flag 405 being set to “switching” may indicate activation of a new group of models and being set to “deactivation” may indicate deactivating the current group of models.

In some examples, A UE-specific MAC-CE may be used to convey the indication to switch to the UE. The dedicated MAC-CE may be used for group switching, for group activation and deactivation, and the like. The UE-specific MAC-CE may utilize signaling configuration 400-a of FIG. 4A, similar to the UE-specific DCI.

Referring next to signaling configuration 400-b of FIG. 4B, a dedicated group common DCI (a DCI transmitted for a group of UEs) may be used to convey the indication to switch. The group common DCI may contain multiple segments, each segment being for a specific UE. Each UE may be (pre)configured with a starting bit to read and a length of bit(s) to be read in the group common DCI. This may signal to the UE the corresponding segmentation of the group common DCI. Each segmentation may contain one or more fields, such as discussed in the UE-specific DCI. Accordingly, the indication to switch conveyed in the unified signaling technique may include a first set of segments 420 associated with a first UE and a second set of segments 425 associated with a second UE. The first set of segments 420 may include two segments and the second set of segments 425 may include four segments, although each set of segments may include some other number of segments. For each UE, the starting segmentation (or field or bit) to read, and the length of the segmentations (or fields or bits) to read, are configured via RRC. Each segmentation (or field) is used to perform a group-based mode switching/activation/deactivation for a set of functions. In this example, seg1 is used to switch between group1 and group2 defined under functions 1 and 2 for UE1 and seg2 is used to switching between group3 and group4 defined under functions 3 and 4 for UE1. Similarly, for UE2, seg1 is used to switching between group 1 and group 2 defined under functions 1 and 2 for UE2; seg2 is used to switching between group 3 and group 4 defined under functions 3 and 4 for UE2; seg3 is used to switching between group 5 and group 6 defined under functions 5 and 6 for UE2; and seg4 is used to switching between group 7 and group 8 defined under functions 7 and 8 for UE2.

Accordingly, the UE may switch the models in the first group being utilized for the functions to the models in the second group for the functions based on the indication to switched constructed according to signaling configuration 400.

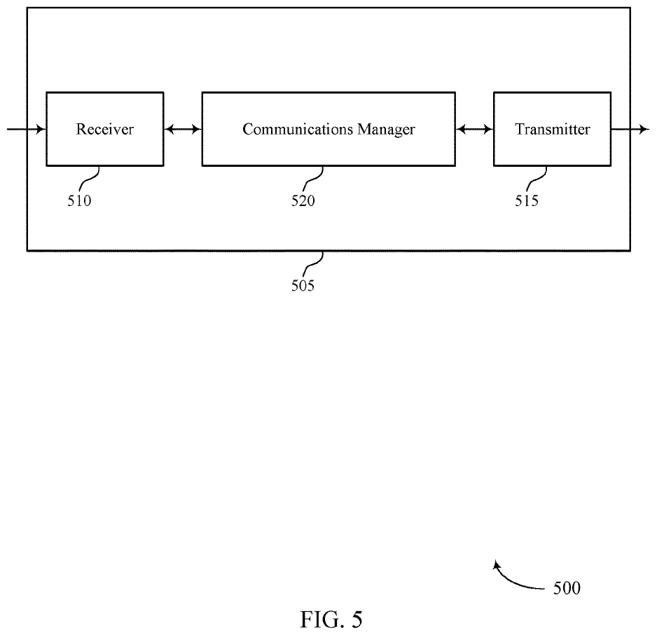

FIG. 5 shows a block diagram 500 of a device 505 that supports model relation and unified switching, activation and deactivation in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to model relation and unified switching, activation and deactivation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to model relation and unified switching, activation and deactivation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of model relation and unified switching, activation and deactivation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for identifying a set of groups, each group in the set of groups including a machine learning model for each of one or more functions implemented by the UE, each machine learning model corresponding to a condition in which each function is implemented by the UE. The communications manager 520 may be configured as or otherwise support a means for receiving an indication to switch from a first group to a second group in the set of groups based on a threshold change of the condition. The communications manager 520 may be configured as or otherwise support a means for switching each associated function implemented by the UE from a first machine learning model associated with the first group to a second machine learning model associated with the second group based on the indication to switch.

Additionally, or alternatively, the communications manager 520 may support wireless communication at a UE in accordance with examples as disclosed herein. For example, the communications manager 520 may be configured as or otherwise support a means for identifying a set of groups, each group in the set of groups including a machine learning model for each of one or more functions implemented by the UE, each machine learning model corresponding to a condition in which each function is implemented by the UE. The communications manager 520 may be configured as or otherwise support a means for determining that a function implemented by the UE according to a first machine learning model in a first group fails to satisfy a performance threshold. The communications manager 520 may be configured as or otherwise support a means for transmitting a report to a network entity indicating that the first group failed to satisfy the performance threshold.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for grouping models for different network functions into groups based upon the conditions under which the functions are being performed. This may enable group based training and registration, group based switching using unified signaling, for group based activation and deactivation, and for model failure reporting on a group-basis.

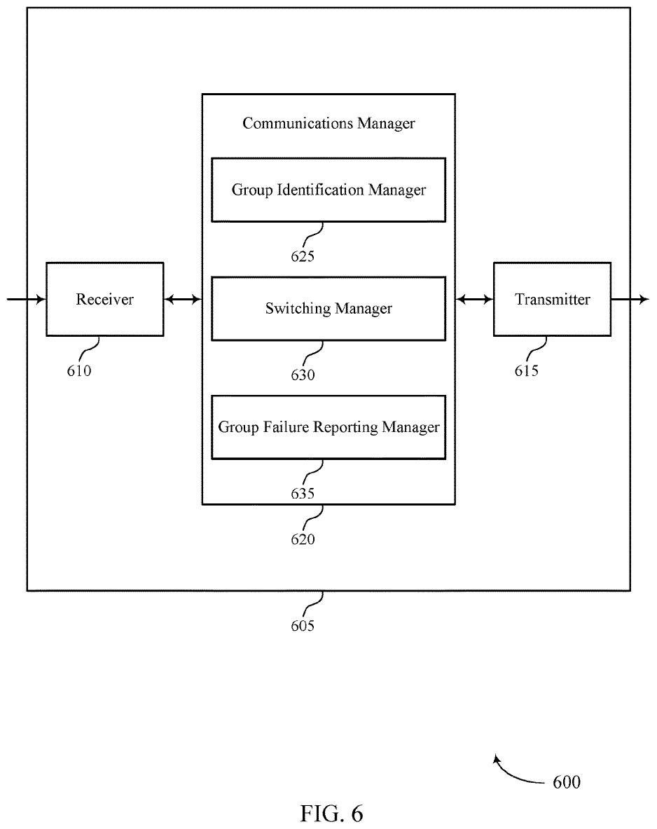

FIG. 6 shows a block diagram 600 of a device 605 that supports model relation and unified switching, activation and deactivation in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to model relation and unified switching, activation and deactivation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to model relation and unified switching, activation and deactivation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of model relation and unified switching, activation and deactivation as described herein. For example, the communications manager 620 may include a group identification manager 625, a switching manager 630, a group failure reporting manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The group identification manager 625 may be configured as or otherwise support a means for identifying a set of groups, each group in the set of groups including a machine learning model for each of one or more functions implemented by the UE, each machine learning model corresponding to a condition in which each function is implemented by the UE. The switching manager 630 may be configured as or otherwise support a means for receiving an indication to switch from a first group to a second group in the set of groups based on a threshold change of the condition. The switching manager 630 may be configured as or otherwise support a means for switching each associated function implemented by the UE from a first machine learning model associated with the first group to a second machine learning model associated with the second group based on the indication to switch.

Additionally, or alternatively, the communications manager 620 may support wireless communication at a UE in accordance with examples as disclosed herein. The group identification manager 625 may be configured as or otherwise support a means for identifying a set of groups, each group in the set of groups including a machine learning model for each of one or more functions implemented by the UE, each machine learning model corresponding to a condition in which each function is implemented by the UE. The group failure reporting manager 635 may be configured as or otherwise support a means for determining that a function implemented by the UE according to a first machine learning model in a first group fails to satisfy a performance threshold.

The group failure reporting manager 635 may be configured as or otherwise support a means for transmitting a report to a network entity indicating that the first group failed to satisfy the performance threshold.

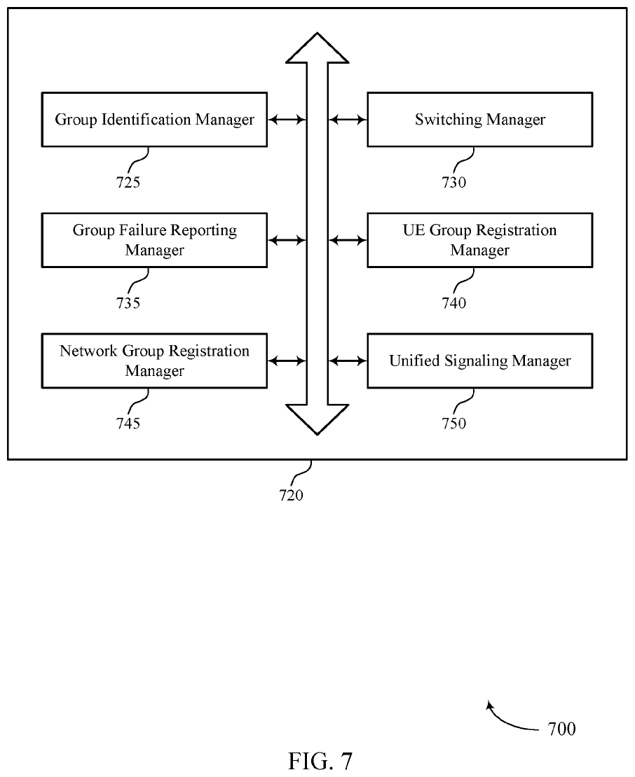

FIG. 7 shows a block diagram 700 of a communications manager 720 that supports model relation and unified switching, activation and deactivation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of model relation and unified switching, activation and deactivation as described herein. For example, the communications manager 720 may include a group identification manager 725, a switching manager 730, a group failure reporting manager 735, a UE group registration manager 740, a network group registration manager 745, a unified signaling manager 750, or any combination thereof. Each of these components may communicate, directly or indirectly, with one another (e.g., via one or more buses).

The communications manager 720 may support wireless communication at a UE in accordance with examples as disclosed herein. The group identification manager 725 may be configured as or otherwise support a means for identifying a set of groups, each group in the set of groups including a machine learning model for each of one or more functions implemented by the UE, each machine learning model corresponding to a condition in which each function is implemented by the UE. The switching manager 730 may be configured as or otherwise support a means for receiving an indication to switch from a first group to a second group in the set of groups based on a threshold change of the condition. In some examples, the switching manager 730 may be configured as or otherwise support a means for switching each associated function implemented by the UE from a first machine learning model associated with the first group to a second machine learning model associated with the second group based on the indication to switch.

In some examples, the UE group registration manager 740 may be configured as or otherwise support a means for transmitting an indication of the set of groups to a network entity to register the set of groups, where the indication to switch is received based on the registering. In some examples, the indication of the set of groups includes, for each model, a group identifier that is unique to each group in the set of groups. In some examples, a shared group identifier among one or more machine learning models define the group. In some examples, the indication of the set of groups includes, for each machine learning model, an associated model or function identifier. In some examples, the associated model or function identifier define the group as including the machine learning model and the associated model or function corresponding to the associated model or function identifier.

In some examples, the network group registration manager 745 may be configured as or otherwise support a means for receiving an indication of the set of groups from a network entity, where the identifying is based on the indication of the set of groups. In some examples, the network group registration manager 745 may be configured as or otherwise support a means for identifying, based on the indication of the set of groups, a group identifier for each machine learning model that is unique to each group in the set of groups, where each group is defined by a shared group identifier among one or more machine learning models.

In some examples, the network group registration manager 745 may be configured as or otherwise support a means for identifying, based on the indication of the set of groups, an associated model or function identifier for each model, where the associated model or function identifier define the group as including the machine learning model and the associated model or function corresponding to the associated model or function identifier. In some examples, to support identifying the set of groups, the network group registration manager 745 may be configured as or otherwise support a means for identifying a first list of machine learning models corresponding to a first function and a second list of machine learning models corresponding to a second function. In some examples, to support identifying the set of groups, the network group registration manager 745 may be configured as or otherwise support a means for identifying the first group based on a first machine learning model from the first list of machine learning models and the first machine learning model from the second list of machine learning models and identifying the second group based on a second machine learning model from the first list of machine learning models and the second machine learning model from the second list of machine learning models. In some examples, the indication is received in RRC signaling or in a MAC-CE.

In some examples, to support identifying the set of groups, the unified signaling manager 750 may be configured as or otherwise support a means for identifying, based on a first field in the indication to switch, the indication to switch from the first group to the second group for a first set of functions implemented by the UE. In some examples, to support identifying the set of groups, the unified signaling manager 750 may be configured as or otherwise support a means for identifying, based on a second field in the indication to switch, an indication to switch from a third group to a fourth group for a second set of functions implemented by the UE. In some examples, the indication to switch indicates that the first group is deactivated, that the second group is activated, or both. In some examples, the indication to switch is received in a UE-specific DCI, in a group common DCI, or in a MAC-CE.

In some examples, the group failure reporting manager 735 may be configured as or otherwise support a means for determining that the function implemented by the UE according to a first machine learning model in the first group fails to satisfy a performance threshold. In some examples, the group failure reporting manager 735 may be configured as or otherwise support a means for transmitting a report to a network entity indicating that the first group failed to satisfy the performance threshold, where the indication to switch is based on the report.

In some examples, the group failure reporting manager 735 may be configured as or otherwise support a means for determining that implementing the function by the UE according to a second machine learning model in the second group satisfies the performance threshold, where the report identifies the second group as a preferred group.

In some examples, the function includes at least one of a CSI feedback function, a channel optimization function, a beam management function, a CSI-RS optimization function, a DMRS function, a physical layer function, a timing function, a synchronization function, a spatial function, a power management function, an interference management function, or a location function. In some examples, the condition includes at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

Additionally, or alternatively, the communications manager 720 may support wireless communication at a UE in accordance with examples as disclosed herein. In some examples, the group identification manager 725 may be configured as or otherwise support a means for identifying a set of groups, each group in the set of groups including a machine learning model for each of one or more functions implemented by the UE, each machine learning model corresponding to a condition in which each function is implemented by the UE. The group failure reporting manager 735 may be configured as or otherwise support a means for determining that a function implemented by the UE according to a first machine learning model in a first group fails to satisfy a performance threshold. In some examples, the group failure reporting manager 735 may be configured as or otherwise support a means for transmitting a report to a network entity indicating that the first group failed to satisfy the performance threshold.

In some examples, the unified signaling manager 750 may be configured as or otherwise support a means for receiving, based on the report, an indication to switch from the first group to a second group in the set of groups. In some examples, the unified signaling manager 750 may be configured as or otherwise support a means for switching the function implemented by the UE from a first machine learning model associated with the first group to a second machine learning model associated with the second group based on the indication to switch.

In some examples, the UE group registration manager 740 may be configured as or otherwise support a means for transmitting an indication of the set of groups to the network entity to register the set of groups.

In some examples, the network group registration manager 745 may be configured as or otherwise support a means for receiving an indication of the set of groups from the network entity, where the identifying is based on the indication of the set of groups.

In some examples, the switching manager 730 may be configured as or otherwise support a means for determining that implementing the function by the UE according to a second machine learning model in a second group satisfies the performance threshold, where the report identifies the second group as a preferred group.

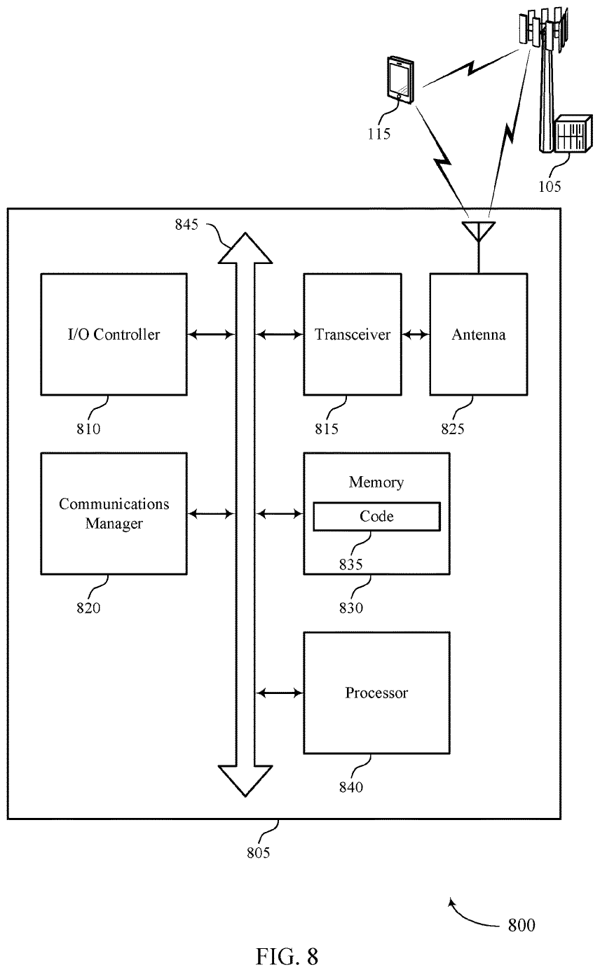

FIG. 8 shows a diagram of a system 800 including a device 805 that supports model relation and unified switching, activation and deactivation in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting model relation and unified switching, activation and deactivation). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for identifying a set of groups, each group in the set of groups including a machine learning model for each of one or more functions implemented by the UE, each machine learning model corresponding to a condition in which each function is implemented by the UE. The communications manager 820 may be configured as or otherwise support a means for receiving an indication to switch from a first group to a second group in the set of groups based on a threshold change of the condition. The communications manager 820 may be configured as or otherwise support a means for switching each associated function implemented by the UE from a first machine learning model associated with the first group to a second machine learning model associated with the second group based on the indication to switch.

Additionally, or alternatively, the communications manager 820 may support wireless communication at a UE in accordance with examples as disclosed herein. For example, the communications manager 820 may be configured as or otherwise support a means for identifying a set of groups, each group in the set of groups including a machine learning model for each of one or more functions implemented by the UE, each machine learning model corresponding to a condition in which each function is implemented by the UE. The communications manager 820 may be configured as or otherwise support a means for determining that a function implemented by the UE according to a first machine learning model in a first group fails to satisfy a performance threshold. The communications manager 820 may be configured as or otherwise support a means for transmitting a report to a network entity indicating that the first group failed to satisfy the performance threshold.

By including or configuring the communications manager 820 in accordance with examples as described herein, the device 805 may support techniques for grouping models for different network functions into groups based upon the conditions under which the functions are being performed. This may enable group based training and registration, group based switching using unified signaling, for group based activation and deactivation, and for model failure reporting on a group-basis.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of model relation and unified switching, activation and deactivation as described herein, or the processor 840 and the memory 830 may be otherwise configured to perform or support such operations.

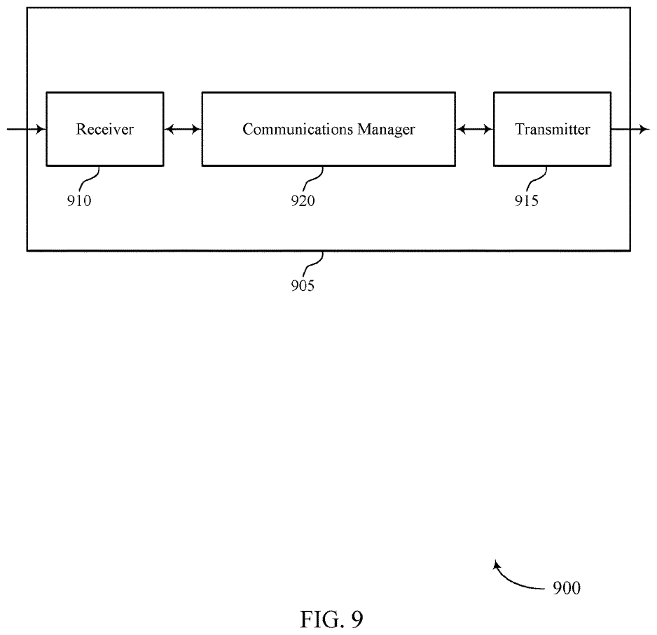

FIG. 9 shows a block diagram 900 of a device 905 that supports model relation and unified switching, activation and deactivation in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of model relation and unified switching, activation and deactivation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for identifying a set of groups for a UE, each group in the set of groups including a machine learning model for each of one or more functions implemented by the UE, each machine learning model corresponding to a condition in which each function is implemented by the UE. The communications manager 920 may be configured as or otherwise support a means for determining that the condition in which each function being implemented by the UE has changed at least a threshold change. The communications manager 920 may be configured as or otherwise support a means for transmitting an indication for the UE to switch from a first group to a second group in the set of groups based on the threshold change of the condition.

Additionally, or alternatively, the communications manager 920 may support wireless communication at a network entity in accordance with examples as disclosed herein. For example, the communications manager 920 may be configured as or otherwise support a means for identifying a set of groups for a UE, each group in the set of groups including a machine learning model for each of one or more functions implemented by the UE, each machine learning model corresponding to a condition in which each function is implemented by the UE. The communications manager 920 may be configured as or otherwise support a means for receiving a report from the UE indicating that a first group in the set of groups failed to satisfy a performance threshold.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for grouping models for different network functions into groups based upon the conditions under which the functions are being performed. This may enable group based training and registration, group based switching using unified signaling, for group based activation and deactivation, and for model failure reporting on a group-basis.

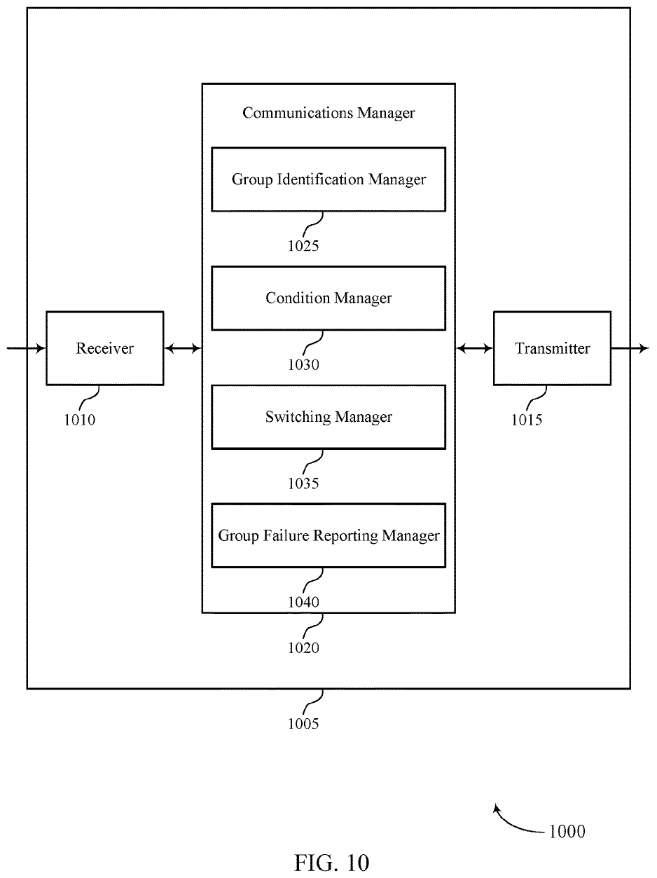

FIG. 10 shows a block diagram 1000 of a device 1005 that supports model relation and unified switching, activation and deactivation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of model relation and unified switching, activation and deactivation as described herein. For example, the communications manager 1020 may include a group identification manager 1025, a condition manager 1030, a switching manager 1035, a group failure reporting manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The group identification manager 1025 may be configured as or otherwise support a means for identifying a set of groups for a UE, each group in the set of groups including a machine learning model for each of one or more functions implemented by the UE, each machine learning model corresponding to a condition in which each function is implemented by the UE. The condition manager 1030 may be configured as or otherwise support a means for determining that the condition in which each function being implemented by the UE has changed at least a threshold change. The switching manager 1035 may be configured as or otherwise support a means for transmitting an indication for the UE to switch from a first group to a second group in the set of groups based on the threshold change of the condition.

Additionally, or alternatively, the communications manager 1020 may support wireless communication at a network entity in accordance with examples as disclosed herein. The group identification manager 1025 may be configured as or otherwise support a means for identifying a set of groups for a UE, each group in the set of groups including a machine learning model for each of one or more functions implemented by the UE, each machine learning model corresponding to a condition in which each function is implemented by the UE. The group failure reporting manager 1040 may be configured as or otherwise support a means for receiving a report from the UE indicating that a first group in the set of groups failed to satisfy a performance threshold.

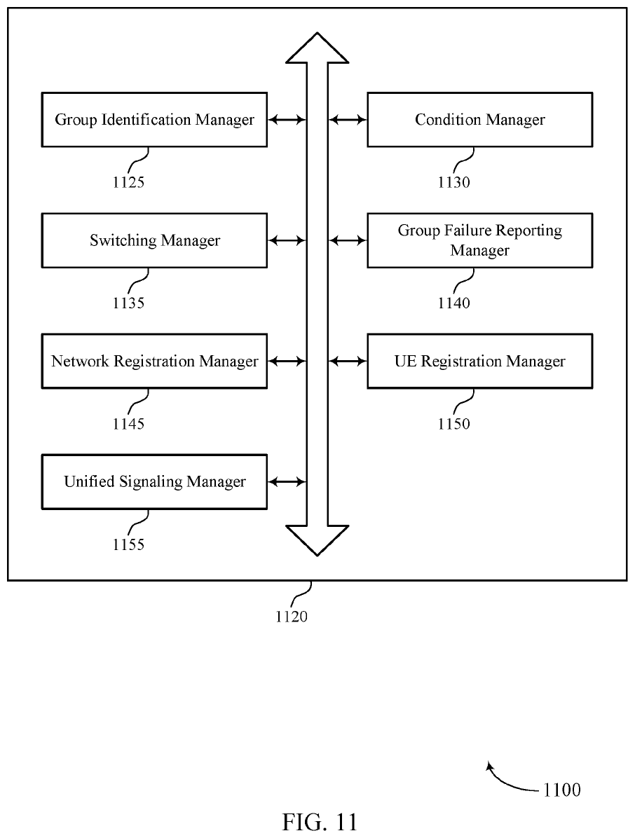

FIG. 11 shows a block diagram 1100 of a communications manager 1120 that supports model relation and unified switching, activation and deactivation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of model relation and unified switching, activation and deactivation as described herein. For example, the communications manager 1120 may include a group identification manager 1125, a condition manager 1130, a switching manager 1135, a group failure reporting manager 1140, a network registration manager 1145, a UE registration manager 1150, a unified signaling manager 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The group identification manager 1125 may be configured as or otherwise support a means for identifying a set of groups for a UE, each group in the set of groups including a machine learning model for each of one or more functions implemented by the UE, each machine learning model corresponding to a condition in which each function is implemented by the UE. The condition manager 1130 may be configured as or otherwise support a means for determining that the condition in which each function being implemented by the UE has changed at least a threshold change. The switching manager 1135 may be configured as or otherwise support a means for transmitting an indication for the UE to switch from a first group to a second group in the set of groups based on the threshold change of the condition.

In some examples, the network registration manager 1145 may be configured as or otherwise support a means for transmitting an indication of the set of groups to the UE to register the set of groups. In some examples, the indication of the set of groups includes, for each machine learning model, a group identifier that is unique to each group in the set of groups. In some examples, a shared group identifier among one or more machine learning models define the group. In some examples, the indication of the set of groups includes, for each machine learning model, an associated model or function identifier. In some examples, the associated model or function identifier define the group as including the machine learning model and the associated model or function corresponding to the associated model or function identifier.

In some examples, the UE registration manager 1150 may be configured as or otherwise support a means for receiving an indication of the set of groups from the UE, where the identifying is based on the indication of the set of groups. In some examples, the UE registration manager 1150 may be configured as or otherwise support a means for identifying, based on the indication of the set of groups, a group identifier for each machine learning model that is unique to each group in the set of groups, where each group is defined by a shared group identifier among one or more machine learning models. In some examples, the UE registration manager 1150 may be configured as or otherwise support a means for identifying, based on the indication of the set of groups, an associated model or function identifier for each model, where the associated model or function identifier define the group as including the machine learning model and the associated model or function corresponding to the associated model or function identifier.

In some examples, to support identifying the set of groups, the UE registration manager 1150 may be configured as or otherwise support a means for identifying a first list of machine learning models corresponding to a first function and a second list of machine learning models corresponding to a second function. In some examples, to support identifying the set of groups, the UE registration manager 1150 may be configured as or otherwise support a means for identifying the first group based on a first machine learning model from the first list of machine learning models and the first machine learning model from the second list of machine learning models and identifying the second group based on a second machine learning model from the first list of machine learning models and the second machine learning model from the second list of machine learning models. In some examples, the indication is received in RRC signaling or in a MAC-CE.

In some examples, to support transmitting the indication to switch, the unified signaling manager 1155 may be configured as or otherwise support a means for transmitting, in the indication to switch, a first field in indicating to switch from the first group to the second group for a first set of functions implemented by the UE and a second field indicating to switch from a third group to a fourth group for a second set of functions implemented by the UE. In some examples, the indication to switch indicates that the first group is deactivated, that the second group is activated, or both. In some examples, the indication to switch is transmitted in a UE-specific DCI, in a group common DCI, or in a MAC-CE.

In some examples, the group failure reporting manager 1140 may be configured as or otherwise support a means for receiving a report from the UE indicating that the function implemented by the UE according to a first machine learning model in the first group fails to satisfy a performance threshold, where the indication to switch to the second group is based on the report. In some examples, the group failure reporting manager 1140 may be configured as or otherwise support a means for determining, based on the report, that the UE implementing the function according to a second machine learning model in the second group satisfies the performance threshold, where the indication to switch to the second group is transmitted based on the report.

In some examples, the function includes at least one of a CSI feedback function, a channel optimization function, a beam management function, a CSI-RS optimization function, a DMRS function, a physical layer function, a timing function, a synchronization function, a spatial function, a power management function, an interference management function, or a location function. In some examples, the condition includes at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

Additionally, or alternatively, the communications manager 1120 may support wireless communication at a network entity in accordance with examples as disclosed herein. In some examples, the group identification manager 1125 may be configured as or otherwise support a means for identifying a set of groups for a UE, each group in the set of groups including a machine learning model for each of one or more functions implemented by the UE, each machine learning model corresponding to a condition in which each function is implemented by the UE. The group failure reporting manager 1140 may be configured as or otherwise support a means for receiving a report from the UE indicating that a first group in the set of groups failed to satisfy a performance threshold.

In some examples, the unified signaling manager 1155 may be configured as or otherwise support a means for transmitting, based on the report, an indication for the UE to switch from the first group to a second group in the set of groups, where the function implemented by the UE is switched from a first machine learning model associated with the first group to a second machine learning model associated with the second group.

In some examples, the UE registration manager 1150 may be configured as or otherwise support a means for receiving an indication of the set of groups from the UE to register the set of groups, where the identifying is based on the indication of the set of groups.

In some examples, the network registration manager 1145 may be configured as or otherwise support a means for transmitting an indication of the set of groups to the UE.

In some examples, the switching manager 1135 may be configured as or otherwise support a means for determining that implementing the function by the UE according to a second machine learning model in a second group satisfies the performance threshold, where the report identifies the second group as a preferred group.

In some examples, the switching manager 1135 may be configured as or otherwise support a means for determining, based on the report, that a function implemented by the UE according to a first machine learning model in the first group fails to satisfy the performance threshold.

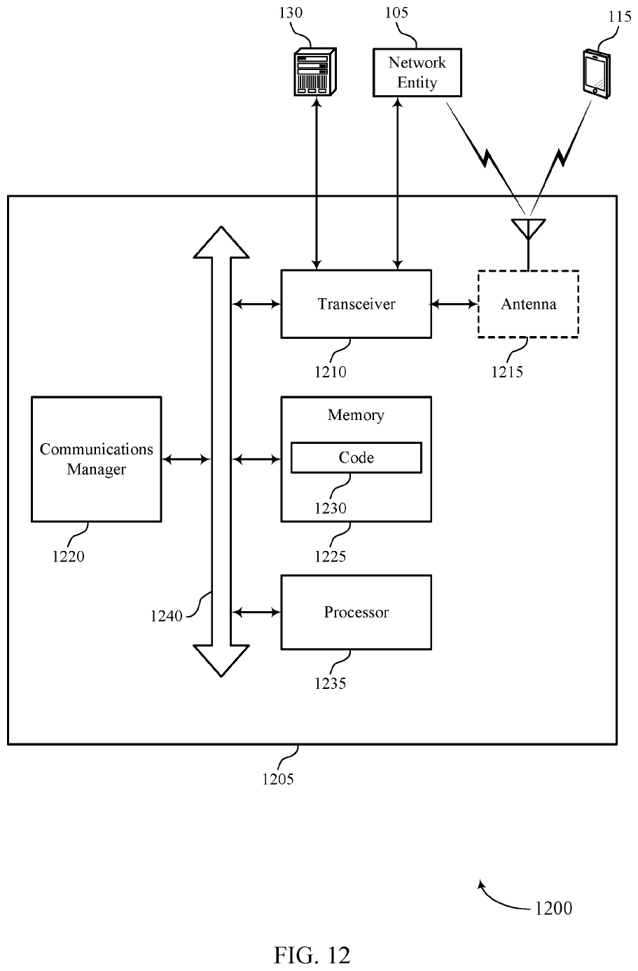

FIG. 12 shows a diagram of a system 1200 including a device 1205 that supports model relation and unified switching, activation and deactivation in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting model relation and unified switching, activation and deactivation). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for identifying a set of groups for a UE, each group in the set of groups including a machine learning model for each of one or more functions implemented by the UE, each machine learning model corresponding to a condition in which each function is implemented by the UE. The communications manager 1220 may be configured as or otherwise support a means for determining that the condition in which each function being implemented by the UE has changed at least a threshold change. The communications manager 1220 may be configured as or otherwise support a means for transmitting an indication for the UE to switch from a first group to a second group in the set of groups based on the threshold change of the condition.

Additionally, or alternatively, the communications manager 1220 may support wireless communication at a network entity in accordance with examples as disclosed herein. For example, the communications manager 1220 may be configured as or otherwise support a means for identifying a set of groups for a UE, each group in the set of groups including a machine learning model for each of one or more functions implemented by the UE, each machine learning model corresponding to a condition in which each function is implemented by the UE. The communications manager 1220 may be configured as or otherwise support a means for receiving a report from the UE indicating that a first group in the set of groups failed to satisfy a performance threshold.

By including or configuring the communications manager 1220 in accordance with examples as described herein, the device 1205 may support techniques for grouping models for different network functions into groups based upon the conditions under which the functions are being performed. This may enable group based training and registration, group based switching using unified signaling, for group based activation and deactivation, and for model failure reporting on a group-basis.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of model relation and unified switching, activation and deactivation as described herein, or the processor 1235 and the memory 1225 may be otherwise configured to perform or support such operations.

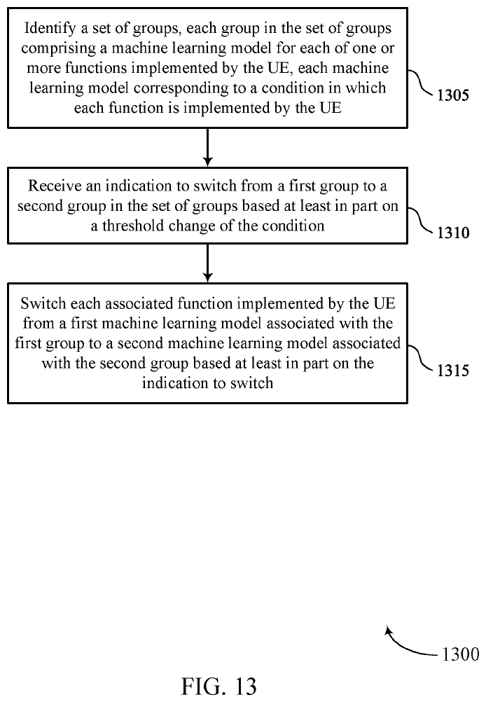

FIG. 13 shows a flowchart illustrating a method 1300 that supports model relation and unified switching, activation and deactivation in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include identifying a set of groups, each group in the set of groups including a machine learning model for each of one or more functions implemented by the UE, each machine learning model corresponding to a condition in which each function is implemented by the UE. The operations of 1305 may be performed in accordance with examples as disclosed herein. In some examples, aspects of the operations of 1305 may be performed by a group identification manager 725 as described with reference to FIG. 7.

At 1310, the method may include receiving an indication to switch from a first group to a second group in the set of groups based on a threshold change of the condition. The operations of 1310 may be performed in accordance with examples as disclosed herein. In some examples, aspects of the operations of 1310 may be performed by a switching manager 730 as described with reference to FIG. 7.

At 1315, the method may include switching each associated function implemented by the UE from a first machine learning model associated with the first group to a second machine learning model associated with the second group based on the indication to switch. The operations of 1315 may be performed in accordance with examples as disclosed herein. In some examples, aspects of the operations of 1315 may be performed by a switching manager 730 as described with reference to FIG. 7.

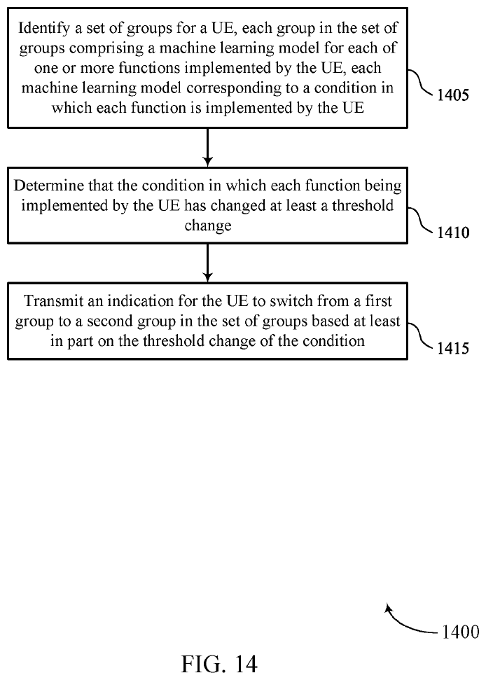

FIG. 14 shows a flowchart illustrating a method 1400 that supports model relation and unified switching, activation and deactivation in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include identifying a set of groups for a UE, each group in the set of groups including a machine learning model for each of one or more functions implemented by the UE, each machine learning model corresponding to a condition in which each function is implemented by the UE. The operations of 1405 may be performed in accordance with examples as disclosed herein. In some examples, aspects of the operations of 1405 may be performed by a group identification manager 1125 as described with reference to FIG. 11.

At 1410, the method may include determining that the condition in which each function being implemented by the UE has changed at least a threshold change.

The operations of 1410 may be performed in accordance with examples as disclosed herein. In some examples, aspects of the operations of 1410 may be performed by a condition manager 1130 as described with reference to FIG. 11.

At 1415, the method may include transmitting an indication for the UE to switch from a first group to a second group in the set of groups based on the threshold change of the condition. The operations of 1415 may be performed in accordance with examples as disclosed herein. In some examples, aspects of the operations of 1415 may be performed by a switching manager 1135 as described with reference to FIG. 11.

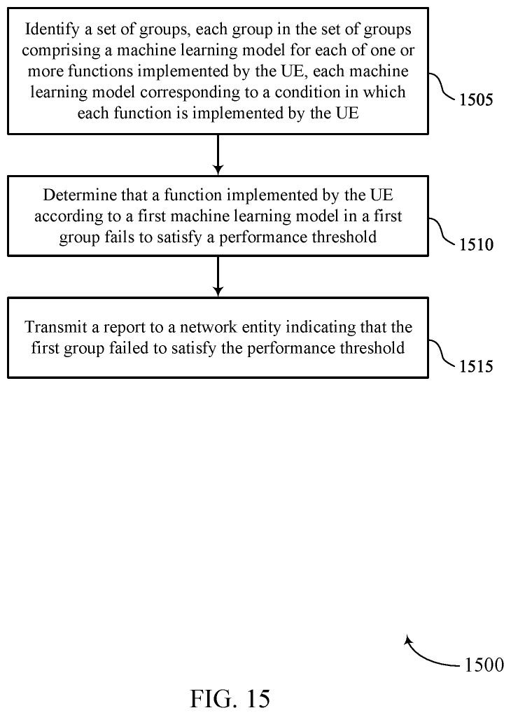

FIG. 15 shows a flowchart illustrating a method 1500 that supports model relation and unified switching, activation and deactivation in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include identifying a set of groups, each group in the set of groups including a machine learning model for each of one or more functions implemented by the UE, each machine learning model corresponding to a condition in which each function is implemented by the UE. The operations of 1505 may be performed in accordance with examples as disclosed herein. In some examples, aspects of the operations of 1505 may be performed by a group identification manager 725 as described with reference to FIG. 7.

At 1510, the method may include determining that a function implemented by the UE according to a first machine learning model in a first group fails to satisfy a performance threshold. The operations of 1510 may be performed in accordance with examples as disclosed herein. In some examples, aspects of the operations of 1510 may be performed by a group failure reporting manager 735 as described with reference to FIG. 7.

At 1515, the method may include transmitting a report to a network entity indicating that the first group failed to satisfy the performance threshold. The operations of 1515 may be performed in accordance with examples as disclosed herein. In some examples, aspects of the operations of 1515 may be performed by a group failure reporting manager 735 as described with reference to FIG. 7.

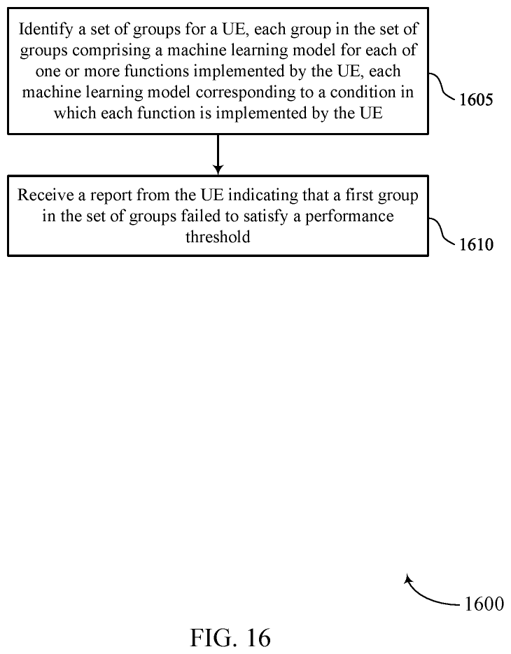

FIG. 16 shows a flowchart illustrating a method 1600 that supports model relation and unified switching, activation and deactivation in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include identifying a set of groups for a UE, each group in the set of groups including a machine learning model for each of one or more functions implemented by the UE, each machine learning model corresponding to a condition in which each function is implemented by the UE. The operations of 1605 may be performed in accordance with examples as disclosed herein. In some examples, aspects of the operations of 1605 may be performed by a group identification manager 1125 as described with reference to FIG. 11.

At 1610, the method may include receiving a report from the UE indicating that a first group in the set of groups failed to satisfy a performance threshold. The operations of 1610 may be performed in accordance with examples as disclosed herein. In some examples, aspects of the operations of 1610 may be performed by a group failure reporting manager 1140 as described with reference to FIG. 11.

The following provides an overview of aspects of the present disclosure:

Aspect 1: A method for wireless communication at a UE, comprising: identifying a set of groups, each group in the set of groups comprising a machine learning model for each of one or more functions implemented by the UE, each machine learning model corresponding to a condition in which each function is implemented by the UE; receiving an indication to switch from a first group to a second group in the set of groups based at least in part on a threshold change of the condition; and switching each associated function implemented by the UE from a first machine learning model associated with the first group to a second machine learning model associated with the second group based at least in part on the indication to switch.

Aspect 2: The method of aspect 1, further comprising: transmitting an indication of the set of groups to a network entity to register the set of groups, wherein the indication to switch is received based at least in part on the registering.

Aspect 3: The method of aspect 2, wherein the indication of the set of groups includes, for each model, a group identifier that is unique to each group in the set of groups, a shared group identifier among one or more machine learning models define the group.

Aspect 4: The method of any of aspects 2 through 3, wherein the indication of the set of groups includes, for each machine learning model, an associated model or function identifier, the associated model or function identifier define the group as including the machine learning model and the associated model or function corresponding to the associated model or function identifier.

Aspect 5: The method of any of aspects 1 through 4, further comprising: receiving an indication of the set of groups from a network entity, wherein the identifying is based at least in part on the indication of the set of groups.

Aspect 6: The method of aspect 5, further comprising: identifying, based at least in part on the indication of the set of groups, a group identifier for each machine learning model that is unique to each group in the set of groups, wherein each group is defined by a shared group identifier among one or more machine learning models.

Aspect 7: The method of any of aspects 5 through 6, further comprising: identifying, based at least in part on the indication of the set of groups, an associated model or function identifier for each model, wherein the associated model or function identifier define the group as including the machine learning model and the associated model or function corresponding to the associated model or function identifier.

Aspect 8: The method of any of aspects 5 through 7, wherein identifying the set of groups comprises: identifying a first list of machine learning models corresponding to a first function and a second list of machine learning models corresponding to a second function; and identifying the first group based at least in part on a first machine learning model from the first list of machine learning models and the first machine learning model from the second list of machine learning models and identifying the second group based at least in part on a second machine learning model from the first list of machine learning models and the second machine learning model from the second list of machine learning models.

Aspect 9: The method of any of aspects 5 through 8, wherein the indication is received in RRC signaling or in a MAC-CE.

Aspect 10: The method of any of aspects 1 through 9, wherein identifying the set of groups comprises: identifying, based at least in part on a first field in the indication to switch, the indication to switch from the first group to the second group for a first set of functions implemented by the UE; and identifying, based at least in part on a second field in the indication to switch, an indication to switch from a third group to a fourth group for a second set of functions implemented by the UE.

Aspect 11: The method of aspect 10, wherein the indication to switch indicates that the first group is deactivated, that the second group is activated, or both.

Aspect 12: The method of any of aspects 10 through 11, wherein the indication to switch is received in a UE-specific DCI, in a group common DCI, or in a MAC-CE.

Aspect 13: The method of any of aspects 1 through 12, further comprising: determining that the function implemented by the UE according to a first machine learning model in the first group fails to satisfy a performance threshold; and transmitting a report to a network entity indicating that the first group failed to satisfy the performance threshold, wherein the indication to switch is based at least in part on the report.

Aspect 14: The method of aspect 13, further comprising: determining that implementing the function by the UE according to a second machine learning model in the second group satisfies the performance threshold, wherein the report identifies the second group as a preferred group.

Aspect 15: The method of any of aspects 1 through 14, wherein the function comprises at least one of a CSI feedback function, a channel optimization function, a beam management function, a CSI-RS optimization function, a DMRS function, a physical layer function, a timing function, a synchronization function, a spatial function, a power management function, an interference management function, or a location function.

Aspect 16: The method of any of aspects 1 through 15, wherein the condition comprises at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

Aspect 17: A method for wireless communication at a network entity, comprising: identifying a set of groups for a UE, each group in the set of groups comprising a machine learning model for each of one or more functions implemented by the UE, each machine learning model corresponding to a condition in which each function is implemented by the UE; determining that the condition in which each function being implemented by the UE has changed at least a threshold change; and transmitting an indication for the UE to switch from a first group to a second group in the set of groups based at least in part on the threshold change of the condition.

Aspect 18: The method of aspect 17, further comprising: transmitting an indication of the set of groups to the UE to register the set of groups.

Aspect 19: The method of aspect 18, wherein the indication of the set of groups includes, for each machine learning model, a group identifier that is unique to each group in the set of groups, a shared group identifier among one or more machine learning models define the group.

Aspect 20: The method of any of aspects 18 through 19, wherein the indication of the set of groups includes, for each machine learning model, an associated model or function identifier, the associated model or function identifier define the group as including the machine learning model and the associated model or function corresponding to the associated model or function identifier.

Aspect 21: The method of any of aspects 17 through 20, further comprising: receiving an indication of the set of groups from the UE, wherein the identifying is based at least in part on the indication of the set of groups.

Aspect 22: The method of aspect 21, further comprising: identifying, based at least in part on the indication of the set of groups, a group identifier for each machine learning model that is unique to each group in the set of groups, wherein each group is defined by a shared group identifier among one or more machine learning models.

Aspect 23: The method of any of aspects 21 through 22, further comprising: identifying, based at least in part on the indication of the set of groups, an associated model or function identifier for each model, wherein the associated model or function identifier define the group as including the machine learning model and the associated model or function corresponding to the associated model or function identifier.

Aspect 24: The method of any of aspects 21 through 23, wherein identifying the set of groups comprises: identifying a first list of machine learning models corresponding to a first function and a second list of machine learning models corresponding to a second function; and identifying the first group based at least in part on a first machine learning model from the first list of machine learning models and the first machine learning model from the second list of machine learning models and identifying the second group based at least in part on a second machine learning model from the first list of machine learning models and the second machine learning model from the second list of machine learning models.

Aspect 25: The method of any of aspects 21 through 24, wherein the indication is received in RRC signaling or in a MAC-CE.

Aspect 26: The method of any of aspects 17 through 25, wherein transmitting the indication to switch comprises: transmitting, in the indication to switch, a first field in indicating to switch from the first group to the second group for a first set of functions implemented by the UE and a second field indicating to switch from a third group to a fourth group for a second set of functions implemented by the UE.

Aspect 27: The method of aspect 26, wherein the indication to switch indicates that the first group is deactivated, that the second group is activated, or both.

Aspect 28: The method of any of aspects 26 through 27, wherein the indication to switch is transmitted in a UE-specific DCI, in a group common DCI, or in a MAC-CE.

Aspect 29: The method of any of aspects 17 through 28, further comprising: receiving a report from the UE indicating that the function implemented by the UE according to a first machine learning model in the first group fails to satisfy a performance threshold, wherein the indication to switch to the second group is based at least in part on the report.

Aspect 30: The method of aspect 29, further comprising: determining, based at least in part on the report, that the UE implementing the function according to a second machine learning model in the second group satisfies the performance threshold, wherein the indication to switch to the second group is transmitted based at least in part on the report.

Aspect 31: The method of any of aspects 17 through 30, wherein the function comprises at least one of a CSI feedback function, a channel optimization function, a beam management function, a CSI-RS optimization function, a DMRS function, a physical layer function, a timing function, a synchronization function, a spatial function, a power management function, an interference management function, or a location function.

Aspect 32: The method of any of aspects 17 through 31, wherein the condition comprises at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

Aspect 33: A method for wireless communication at a UE, comprising: identifying a set of groups, each group in the set of groups comprising a machine learning model for each of one or more functions implemented by the UE, each machine learning model corresponding to a condition in which each function is implemented by the UE; determining that a function implemented by the UE according to a first machine learning model in a first group fails to satisfy a performance threshold; and transmitting a report to a network entity indicating that the first group failed to satisfy the performance threshold.

Aspect 34: The method of aspect 33, further comprising: receiving, based at least in part on the report, an indication to switch from the first group to a second group in the set of groups; and switching the function implemented by the UE from a first machine learning model associated with the first group to a second machine learning model associated with the second group based at least in part on the indication to switch.

Aspect 35: The method of any of aspects 33 through 34, further comprising: transmitting an indication of the set of groups to the network entity to register the set of groups.

Aspect 36: The method of any of aspects 33 through 35, further comprising: receiving an indication of the set of groups from the network entity, wherein the identifying is based at least in part on the indication.

Aspect 37: The method of any of aspects 33 through 36, further comprising: determining that implementing the function by the UE according to a second machine learning model in a second group satisfies the performance threshold, wherein the report identifies the second group as a preferred group.

Aspect 38: A method for wireless communication at a network entity, comprising: identifying a set of groups for a UE, each group in the set of groups comprising a machine learning model for each of one or more functions implemented by the UE, each machine learning model corresponding to a condition in which each function is implemented by the UE; and receiving a report from the UE indicating that a first group in the set of groups failed to satisfy a performance threshold.

Aspect 39: The method of aspect 38, further comprising: transmitting, based at least in part on the report, an indication for the UE to switch from the first group to a second group in the set of groups, wherein the function implemented by the UE is switched from a first machine learning model associated with the first group to a second machine learning model associated with the second group.

Aspect 40: The method of any of aspects 38 through 39, further comprising: receiving an indication of the set of groups from the UE to register the set of groups, wherein the identifying is based at least in part on the indication.

Aspect 41: The method of any of aspects 38 through 40, further comprising: transmitting an indication of the set of groups to the UE.

Aspect 42: The method of any of aspects 38 through 41, further comprising: determining that implementing the function by the UE according to a second machine learning model in a second group satisfies the performance threshold, wherein the report identifies the second group as a preferred group.

Aspect 43: The method of any of aspects 38 through 42, further comprising: determining, based at least in part on the report, that a function implemented by the UE according to a first machine learning model in the first group fails to satisfy the performance threshold.

Aspect 44: An apparatus for wireless communication at a UE, comprising a processor; memory coupled with the processor; and instructions stored in the memory and executable by the processor to cause the apparatus to perform a method of any of aspects 1 through 16.

Aspect 45: An apparatus for wireless communication at a UE, comprising at least one means for performing a method of any of aspects 1 through 16.

Aspect 46: A non-transitory computer-readable medium storing code for wireless communication at a UE, the code comprising instructions executable by a processor to perform a method of any of aspects 1 through 16.

Aspect 47: An apparatus for wireless communication at a network entity, comprising a processor; memory coupled with the processor; and instructions stored in the memory and executable by the processor to cause the apparatus to perform a method of any of aspects 17 through 32.

Aspect 48: An apparatus for wireless communication at a network entity, comprising at least one means for performing a method of any of aspects 17 through 32.

Aspect 49: A non-transitory computer-readable medium storing code for wireless communication at a network entity, the code comprising instructions executable by a processor to perform a method of any of aspects 17 through 32.

Aspect 50: An apparatus for wireless communication at a UE, comprising a processor; memory coupled with the processor; and instructions stored in the memory and executable by the processor to cause the apparatus to perform a method of any of aspects 33 through 37.

Aspect 51: An apparatus for wireless communication at a UE, comprising at least one means for performing a method of any of aspects 33 through 37.

Aspect 52: A non-transitory computer-readable medium storing code for wireless communication at a UE, the code comprising instructions executable by a processor to perform a method of any of aspects 33 through 37.

Aspect 53: An apparatus for wireless communication at a network entity, comprising a processor; memory coupled with the processor; and instructions stored in the memory and executable by the processor to cause the apparatus to perform a method of any of aspects 38 through 43.

Aspect 54: An apparatus for wireless communication at a network entity, comprising at least one means for performing a method of any of aspects 38 through 43.

Aspect 55: A non-transitory computer-readable medium storing code for wireless communication at a network entity, the code comprising instructions executable by a processor to perform a method of any of aspects 38 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
identify a set of groups, each group in the set of groups comprising a machine learning model for each of one or more functions implemented by the UE, each machine learning model corresponding to a condition in which each function is implemented by the UE;
receive an indication to switch from a first group to a second group in the set of groups based at least in part on a threshold change of the condition; and
switch each associated function implemented by the UE from a first machine learning model associated with the first group to a second machine learning model associated with the second group based at least in part on the indication to switch.

2. The apparatus of claim 1, wherein the instructions are further executable by the processor to cause the apparatus to:
transmit an indication of the set of groups to a network entity to register the set of groups, wherein the indication to switch is received based at least in part on the registering.

3. The apparatus of claim 2, wherein:
the indication of the set of groups includes, for each model, a group identifier that is unique to each group in the set of groups, and
a shared group identifier among one or more machine learning models define the group.

4. The apparatus of claim 2, wherein:
the indication of the set of groups includes, for each machine learning model, an associated model or function identifier, and
the associated model or function identifier define the group as including the machine learning model and the associated model or function corresponding to the associated model or function identifier.

5. The apparatus of claim 1, wherein the instructions are further executable by the processor to cause the apparatus to:
receive an indication of the set of groups from a network entity, wherein the identifying is based at least in part on the indication of the set of groups.

6. The apparatus of claim 5, wherein the instructions are further executable by the processor to cause the apparatus to:
identify, based at least in part on the indication of the set of groups, a group identifier for each machine learning model that is unique to each group in the set of groups, wherein each group is defined by a shared group identifier among one or more machine learning models.

7. The apparatus of claim 5, wherein the instructions are further executable by the processor to cause the apparatus to:
identify, based at least in part on the indication of the set of groups, an associated model or function identifier for each model, wherein the associated model or function identifier define the group as including the machine learning model and the associated model or function corresponding to the associated model or function identifier.

8. The apparatus of claim 5, wherein the instructions to identify the set of groups are executable by the processor to cause the apparatus to:
identify a first list of machine learning models corresponding to a first function and a second list of machine learning models corresponding to a second function; and
identify the first group based at least in part on a first machine learning model from the first list of machine learning models and the first machine learning model from the second list of machine learning models and identifying the second group based at least in part on a second machine learning model from the first list of machine learning models and the second machine learning model from the second list of machine learning models.

9. The apparatus of claim 5, wherein the indication is received in radio resource control (RRC) signaling or in a medium access control-control element (MAC-CE).

10. The apparatus of claim 1, wherein the instructions to identify the set of groups are executable by the processor to cause the apparatus to:
identify, based at least in part on a first field in the indication to switch, the indication to switch from the first group to the second group for a first set of functions implemented by the UE; and
identify, based at least in part on a second field in the indication to switch, an indication to switch from a third group to a fourth group for a second set of functions implemented by the UE.

11. The apparatus of claim 10, wherein the indication to switch indicates that the first group is deactivated, that the second group is activated, or both.

12. The apparatus of claim 10, wherein the indication to switch is received in a UE-specific downlink control information (DCI), in a group common DCI, or in a medium access control-control element (MAC-CE).

13. The apparatus of claim 1, wherein the instructions are further executable by the processor to cause the apparatus to:
determine that the function implemented by the UE according to a first machine learning model in the first group fails to satisfy a performance threshold; and
transmit a report to a network entity indicating that the first group failed to satisfy the performance threshold, wherein the indication to switch is based at least in part on the report.

14. The apparatus of claim 13, wherein the instructions are further executable by the processor to cause the apparatus to:
determine that implementing the function by the UE according to a second machine learning model in the second group satisfies the performance threshold, wherein the report identifies the second group as a preferred group.

15. The apparatus of claim 1, wherein the function comprises at least one of a channel state information (CSI) feedback function, a channel optimization function, a beam management function, a CSI-reference signal (RS) optimization function, a demodulation reference signal (DMRS) function, a physical layer function, a timing function, a synchronization function, a spatial function, a power management function, an interference management function, or a location function.

16. The apparatus of claim 1, wherein the condition comprises at least one of a doppler condition, an angular speed condition, a travel direction condition, a travel speed condition, a beamwidth condition, a beam condition, a power condition, an interference condition, a traffic load condition, a traffic pattern condition, a traffic type condition, a reference signal configuration condition, a location condition, an antenna configuration condition, a coverage condition, a connection condition, or a change in one or more of conditions.

17. An apparatus for wireless communication at a network entity, comprising:
a processor;
memory coupled with the processor; and
instructions stored in the memory and executable by the processor to cause the apparatus to:
identify a set of groups for a user equipment (UE), each group in the set of groups comprising a machine learning model for each of one or more functions implemented by the UE, each machine learning model corresponding to a condition in which each function is implemented by the UE;
determine that the condition in which each function being implemented by the UE has changed at least a threshold change; and
transmit an indication for the UE to switch from a first group to a second group in the set of groups based at least in part on the threshold change of the condition.

18. The apparatus of claim 17, wherein the instructions are further executable by the processor to cause the apparatus to:
transmit an indication of the set of groups to the UE to register the set of groups.

19. The apparatus of claim 18, wherein:
the indication of the set of groups includes, for each machine learning model, a group identifier that is unique to each group in the set of groups, and
a shared group identifier among one or more machine learning models define the group.

20. The apparatus of claim 18, wherein:
the indication of the set of groups includes, for each machine learning model, an associated model or function identifier, and
the associated model or function identifier define the group as including the machine learning model and the associated model or function corresponding to the associated model or function identifier.

21. The apparatus of claim 17, wherein the instructions are further executable by the processor to cause the apparatus to:
receive an indication of the set of groups from the UE, wherein the identifying is based at least in part on the indication of the set of groups.

22. The apparatus of claim 21, wherein the instructions are further executable by the processor to cause the apparatus to:
identify, based at least in part on the indication of the set of groups, a group identifier for each machine learning model that is unique to each group in the set of groups, wherein each group is defined by a shared group identifier among one or more machine learning models.

23. The apparatus of claim 21, wherein the instructions are further executable by the processor to cause the apparatus to:
identify, based at least in part on the indication of the set of groups, an associated model or function identifier for each model, wherein the associated model or function identifier define the group as including the machine learning model and the associated model or function corresponding to the associated model or function identifier.

24. The apparatus of claim 21, wherein the instructions to identify the set of groups are executable by the processor to cause the apparatus to:
identify a first list of machine learning models corresponding to a first function and a second list of machine learning models corresponding to a second function; and
identify the first group based at least in part on a first machine learning model from the first list of machine learning models and the first machine learning model from the second list of machine learning models and identifying the second group based at least in part on a second machine learning model from the first list of machine learning models and the second machine learning model from the second list of machine learning models.

25. The apparatus of claim 21, wherein the indication is received in radio resource control (RRC) signaling or in a medium access control-control element (MAC-CE).

26. The apparatus of claim 17, wherein the instructions to transmit the indication to switch are executable by the processor to cause the apparatus to:
transmit, in the indication to switch, a first field in indicating to switch from the first group to the second group for a first set of functions implemented by the UE and a second field indicating to switch from a third group to a fourth group for a second set of functions implemented by the UE.

27. The apparatus of claim 26, wherein the indication to switch indicates that the first group is deactivated, that the second group is activated, or both.

28-32. (canceled)

33. A method for wireless communication at a user equipment (UE), comprising:
identifying a set of groups, each group in the set of groups comprising a machine learning model for each of one or more functions implemented by the UE, each machine learning model corresponding to a condition in which each function is implemented by the UE;
receiving an indication to switch from a first group to a second group in the set of groups based at least in part on a threshold change of the condition; and
switching each associated function implemented by the UE from a first machine learning model associated with the first group to a second machine learning model associated with the second group based at least in part on the indication to switch.

34. The method of claim 33, further comprising:
transmitting an indication of the set of groups to a network entity to register the set of groups, wherein the indication to switch is received based at least in part on the registering.

35. A method for wireless communication at a network entity, comprising:
identifying a set of groups for a user equipment (UE), each group in the set of groups comprising a machine learning model for each of one or more functions implemented by the UE, each machine learning model corresponding to a condition in which each function is implemented by the UE;
determining that the condition in which each function being implemented by the UE has changed at least a threshold change; and
transmitting an indication for the UE to switch from a first group to a second group in the set of groups based at least in part on the threshold change of the condition.
